(19) United States
(12) Patent Application Publication
(10) Pub. No.: US 2023/0028686 A1
(43) Pub. Date: Jan. 26, 2023

(54) INJECTOR APPARATUS

(71) Applicant: RKLAB AG, Root D4 (CH)

(72) Inventors: Daniel EASTWOOD, Shoreham-by-Sea West Sussex (GB); Riccardo MELDOLESI, Shoreham-by-Sea West Sussex (GB); Martin SELWAY, Shoreham-by-Sea West Sussex (GB); John LUTWYCHE, Shoreham-by-Sea West Sussex (GB)

(73) Assignee: RKLAB AG, Root D4 (CH)

(21) Appl. No.: 17/783,328

(22) PCT Filed: Dec. 9, 2020
(86) PCT No.: PCT/EP2020/085354

§ 371 Date: Jun. 8, 2022

(30) Foreign Application Priority Data
Dec. 9, 2019 (GB) 1918015.7

(51) Int. Cl. F02M 49/02; F02D 41/30; F02M 61/00; F02M 63/00

(52) U.S. Cl. CPC F02M 49/02; F02D 41/30; F02M 61/00; F02M 63/00; F02M 2547/008

(57) ABSTRACT

An injector apparatus (110) for injecting fluid under pressure into an associated chamber (132), the apparatus including a body (112), a first piston (114) moveable in the body, the first piston defining a first working area facing an associated chamber (132), a high pressure piston (18,118) defining a high pressure working area facing a high pressure chamber (19), the first working area being greater than the high pressure working area, the first piston (114) being operable to compress fluid in the high pressure chamber using the high pressure piston (118), the injector apparatus (110) having a first configuration having a first ratio of the first working area to high pressure working area and having a second configuration having a second ratio of the first working area to the high pressure working area, wherein a first ratio is different from the second ratio.

The present invention relates to an injector apparatus and to internal combustion engines comprising such injector apparatuses.

Although the present invention is described with reference to fuel injectors used in internal combustion engines, it is applicable to any injector apparatus for injecting a fluid under pressure into an associated chamber.

Fuel injectors used in internal combustion engines, including both spark ignition and compression ignition (or diesel) engines, generally utilise an external pump for supplying the fuel under sufficient pressure to be injected into the engine cylinder. The timing of the injection point in the engine operating cycle is determined by external controlling of the operation of an injector valve by a mechanical or electrical means. One disadvantage of providing external pumping and the control is the need for the provision of servicing of such external systems.

According to a first aspect of the present invention, there is provided an injector apparatus for injecting fluid under pressure into an associated chamber, the apparatus including
a body,
a first piston moveable in the body, the first piston defining a first working area facing an associated chamber,
a high pressure piston defining a high pressure working area facing a high pressure chamber,
the first working area being greater than the high pressure working area, the first piston being operable to compress fluid in the high pressure chamber using the high pressure piston,
the first piston further defining an injector orifice through which the fluid can be injected into an associated chamber from the high pressure chamber and defining a valve seat,
a valve member selectively operable to engage the valve seat to operably isolate the high pressure chamber from the injector orifice and selectively operable to disengage the valve seat to fluidly connect the high pressure chamber with the injector orifice. With this arrangement, the injector apparatus is operable to generate very high injection pressures using the pressure within the combustion chamber without the need for an external high pressure pump.

The valve member may be moveable relative to the body.

The first piston may be moveable relative to the body in a first direction and the valve member may be moveable relative to the body in the first direction.

The injector apparatus may have a first apparatus position wherein
the first piston is in a piston first position, the valve member is in a first valve member position and the valve member is engaged with the valve seat,
the injector apparatus having a second apparatus position wherein
the first piston is in a piston second position displaced in the first direction by a first distance from the piston first position, the valve member is in a second valve member position displaced in the first direction by the first distance from the first valve member position
and the valve member is engaged with the valve seat.

The injector apparatus may have a first intermediate apparatus position wherein the first piston is positioned between the piston first position and the piston second position, the valve member is positioned between the first valve member position and the second valve member position
and the valve member is disengaged from the valve seat.

The first piston may be moveable relative to the body in a second direction opposite to the first direction and the valve member is moveable relative to the body in the second direction.

The injector apparatus may have a second intermediate apparatus position wherein the first piston is positioned between the piston first position and piston second position, the valve member is positioned between the first valve member position and the second valve member position
and the valve member is engaged with the valve seat.

The valve member may have an elongate stem having a first end having a valve surface for selective engagement with the valve seat.

The injector apparatus may include a control chamber and movement of the first piston is selectively controllable by controlling the fluid in the control chamber.

The control chamber may be partially defined by the valve member.

The control chamber may be partially defined by an end surface of a second end of the elongate stem opposite the first end.

The injector apparatus may include a control chamber vent valve operable to vent the control chamber to a low pressure region.

The injector apparatus may be configured so that operating the control chamber vent valve to vent the control chamber to a low pressure region allows the valve member to disengage the valve seat.

The first piston may be unitary with the high pressure piston.

The high pressure piston may be annular.

At least a part of the elongate stem may be received in the high pressure piston.

The first piston may be concentric with the high pressure piston.

The control chamber may be partially defined by a wall of the body.

The surface of the body may define a wall of the body and the valve member is partially received within said wall of the body.

The valve member may be in sliding engagement with the wall of the body.

The control chamber may be partially defined by a wall of the first piston.

The valve member may be partially received within the wall of the first piston.

The valve member may be in sliding engagement with the wall of the first piston.

The wall of the first piston may be an inside wall and the control chamber is fluidly connected to an outside wall of the first piston via a first fluid path, the outside wall being in sliding engagement with a bore of the body, the bore of the body including a second fluid path.

The outside wall and/or the bore of the body may have a recess to fluidly connect the first fluid path with the second fluid path.

The recess may be a groove.

The first piston may be separate from the high pressure piston.

The high pressure piston may be cylindrical.

The first piston may not be concentric with the high pressure piston.

The high pressure piston may be defined by a plurality of high pressure pistons and the high pressure chamber is defined by a corresponding plurality of high pressure chambers and the high pressure working area is defined by the plurality of high pressure pistons facing the corresponding high pressure chambers.

The injector apparatus may have just two high pressure pistons and just two corresponding high pressure chambers, or having just three high pressure pistons and just three corresponding high pressure chambers, or having just four high pressure pistons and just four corresponding high pressure chambers.

The injector apparatus may include return spring configured to bias the first piston towards the associated chamber during use.

The first piston may be freely moveable relative to the body. In such embodiments, the first piston is moved towards and away from the associated chamber during use due to pressure imbalances above and below the first piston. Alternatively, the injector apparatus may further comprise a return spring configured to bias the first piston towards the associated chamber during use. In this manner, it can be possible to supply the injector apparatus with fluid even when the pressure in the combustion chamber is higher than on the opposite side of the first piston. This can provide greater flexibility in the amount and timing of a flow of low pressure fluid into the injector apparatus for cooling during operation.

According to an aspect of the present invention there is provided a reciprocating internal combustion engine comprising at least one combustion chamber and at least one injector apparatus according to the first aspect, the at least one injector apparatus being configured to inject fluid under pressure into the at least one combustion chamber.

According to an aspect of the present invention, there is provided an injector apparatus for injecting fluid under pressure into an associated chamber, the apparatus including
a body,
   a first piston moveable in the body, the first piston defining a first working area facing an associated chamber,
a high pressure piston defining a high pressure working area facing a high pressure chamber,
the first working area being greater than the high pressure working area, the first piston being operable to compress fluid in the high pressure chamber using the high pressure piston
the first piston defining a first axis,
the high pressure piston defining a second axis,
wherein the second axis is offset from the first axis.

The high pressure piston may be a first high pressure piston and the high pressure chamber may be a first high pressure chamber, the injector apparatus including a second high pressure piston facing a second high pressure chamber and the high pressure working area is defined by the first high pressure piston facing the first high pressure chamber and the second high pressure piston facing the second high pressure chamber.

The second high pressure piston may define a second high pressure piston axis wherein the second high pressure piston axis is offset from the first axis.

The high pressure piston may be a first high pressure piston and the high pressure chamber may be a first high pressure chamber, the injector apparatus including a plurality of further high pressure pistons facing a corresponding plurality of further high pressure chambers and the high pressure working area is defined by the first high pressure piston facing the first high pressure chamber and the plurality of further high pressure pistons facing the corresponding plurality of further high pressure chambers.

Each further high pressure piston may define a corresponding further high pressure piston axis and all of the further high pressure piston axes are offset from the first axis.

According to a further aspect of the present invention, there is provided an injector apparatus for injecting fluid under pressure into an associated chamber, the apparatus may include
a body,
   a first piston moveable in the body, the first piston defining a first working area facing an associated chamber,
a high pressure piston defining a high pressure working area facing a high pressure chamber,
the first working area being greater than the high pressure working area, the first piston being operable to compress fluid in the high pressure chamber using the high pressure piston
the injector apparatus having a first configuration having a first ratio of the first working area to high pressure working area and having a second configuration having a second ratio of the first working area to the high pressure working area,
wherein a first ratio is different from the second ratio.

The high pressure piston may be defined by a plurality of high pressure pistons and the high pressure chamber may be defined by a corresponding plurality of high pressure chambers and
the high pressure working area of first ratio may be defined by a first selection of the plurality of high pressure pistons facing the corresponding high pressure chambers and
the high pressure working area of the second ratio may be defined by a second selection of the plurality of high pressure pistons facing the corresponding high pressure chambers,
wherein the first selection may be different to the second selection.

The first selection may be all of the plurality of high pressure pistons facing the corresponding high pressure chambers and the second selection may not be all of the plurality of high pressure pistons facing the corresponding high pressure chambers.

The first selection may not be all of the plurality of high pressure pistons facing the corresponding high pressure chamber and the second selection may not be all of the plurality of high pressure pistons facing the corresponding high pressure chamber.

The injector apparatus may have a third configuration having a third ratio of the first working area to high pressure working area wherein the third ratio may be different to the first ratio and second ration.

The high pressure working area of the third ratio may be defined by a third selection of the plurality of high pressure pistons facing the corresponding high pressure chambers, the third selection being different to the first selection and second selection.

When in the second configuration at least one high pressure chamber may be vented to a low pressure region.

The injector apparatus may include return spring configured to bias the first piston towards the associated chamber during use.

The first piston may be freely moveable relative to the body. In such embodiments, the first piston is moved towards and away from the associated chamber during use due to pressure imbalances above and below the first piston. Alternatively, the injector apparatus may further comprise a return spring configured to bias the first piston towards the associated chamber during use. In this manner, it can be possible to supply the injector apparatus with fluid even when the pressure in the combustion chamber is higher than on the opposite side of the first piston. This can provide greater flexibility in the amount and timing of a flow of low pressure fluid into the injector apparatus for cooling during operation.

According to an aspect of the invention, there is provided an injector apparatus for injecting fluid under pressure into an associated chamber, the apparatus including: a body, a first piston moveable in the body, the first piston defining a first working area facing an associated chamber, a high pressure piston defining a high pressure working area facing a high pressure chamber, the first working area being greater than the high pressure working area, the first piston being operable to compress fluid in the high pressure chamber using the high pressure piston, and a control piston defining a control piston working area facing a control chamber, wherein movement of the first piston is selectively controllable by controlling the fluid in the control chamber, wherein the first working area is larger than the control pressure working area and the control pressure working area is larger than the high pressure working area.

With this arrangement, the injector apparatus is operable to generate very high injection pressures using the pressure within the combustion chamber without the need for an external high pressure pump. Further, the first piston can be hydraulically locked using fluid in a control chamber which is pressurised by the control piston and can be hydraulically unlocked by venting the control chamber without the need to vent the high pressure chamber. By providing a control piston with a working area which is larger than the high pressure working area and smaller than the first piston working area, the fluid pressure in the control chamber is higher than the pressure in the associated chamber. This means that the amount of fluid that must be vented to initiate injection during each injection cycle can be reduced. This can reduce the time taken to vent the injector prior to injection and can reduce the number and capacity of vent valves required.

The first piston may define at least a part of the high pressure chamber. The high pressure chamber may be defined by the body of the injector. In such embodiments, the first piston may define at least a part of the high pressure piston which faces the high pressure chamber.

The first piston may define a high pressure bore of the high pressure chamber within which the high pressure piston is positioned.

The high pressure piston may be fixed relative to the body.

The high pressure piston may be moveable relative to the body.

The first piston may comprise the control piston. The control piston may be unitary with the first piston. In other embodiments, the control piston may be distinct from the first piston and connected to it by one or more intermediate elements.

The control piston may be annular. The control piston may be cylindrical. The control piston may have any other suitable cross-sectional shape, including but not limited to oval, elliptical, triangular, square, rectangular, pentagonal, hexagonal, or other regular or irregular polygonal shape.

The control piston working area may be annular. The control piston working area may be circular. The control piston working area may have any other suitable shape, including but not limited to oval, elliptical, triangular, square, rectangular, pentagonal, hexagonal, or other regular or irregular polygonal shape.

The control chamber may define a control chamber bore within which the control piston is positioned. The control chamber bore may be fixed relative to the body. In other embodiments, the control piston may be positioned in a further chamber in fluid communication with the control chamber.

The first piston may include an injector orifice through which fluid can be injected into an associated chamber from the high pressure chamber. In other examples, the injector orifice may be provided as part of one or more other components of the injector apparatus. For example, the injector orifice may be provided as part of an injector nozzle forming part of the injector apparatus. The injector nozzle may be connected to the first piston.

The injector apparatus may further include a first valve, or “control chamber vent valve”, operable to vent the control chamber to a lower pressure region. Alternatively, or in addition, the injector apparatus may further include a second valve, or “high pressure chamber vent valve”, operable to vent the high pressure chamber to a low pressure region.

The lower pressure region may be a tank or reservoir. The lower pressure region may be configured to store fluid to be injected. The lower pressure region may contain fluid to be injected. The lower pressure region may be open to the atmosphere.

The injector apparatus may further include a low pressure chamber at least partially defined by the first piston and a bore of the body and configured to displace fluid to a low pressure region during injection.

The control chamber may be fluidly connected to the low pressure chamber via a first passage in which a control chamber vent valve is located, the control chamber vent valve being operable to vent the control chamber to the low pressure chamber. For example, the control chamber vent valve may be operable to vent the control chamber to the low pressure chamber in order to initiate fluid injection.

The control chamber vent valve may be operable to permit the supply of fluid to the control chamber from the low pressure chamber via the first passage. For example, the control chamber vent valve may be operable to permit the supply of fluid to the control chamber from the low pressure chamber in order to fill the control chamber with fluid prior to injection.

The high pressure chamber may be fluidly connected to the low pressure chamber via a second passage in which a high pressure chamber vent valve is located, the high pressure chamber vent valve being operable to vent the high pressure chamber to the low pressure chamber. For example, the high pressure chamber vent valve may be operable to vent the high pressure chamber to the low pressure chamber in order to stop fluid injection.

The high pressure chamber vent valve may be operable to permit the supply of fluid to the high pressure chamber from the low pressure chamber via the second passage. For example, the high pressure chamber vent valve may be operable to permit the supply of fluid to the high pressure chamber from the low pressure chamber in order to fill the high pressure chamber with fluid prior to injection.

The low pressure chamber may be at least partly defined by an annular bore of the first piston. Where the first piston comprises the control piston, the low pressure chamber may be at least partly defined by an annular bore of the first piston extending around the control piston and located between an outer surface of the control piston and an outer wall of the first piston. The low pressure chamber may be at least partly defined by an annular bore in the body of the injector apparatus. The low pressure chamber may be defined by an annular bore of the first piston and by an annular bore in the body of the injector apparatus which are fluidly connected.

The injector apparatus may further comprise a return valve between the low pressure chamber and the low pressure region, wherein the return valve is operable to fluidly connect the low pressure chamber to the low pressure region. The return valve may be operable to fluidly connect the low pressure chamber to the low pressure region prior to injection in order to vent fluid from the low pressure chamber to the low pressure region prior to injection. The return valve may be operable to fluidly connect the low pressure chamber to the low pressure region during injection in order to vent fluid from the low pressure chamber to the low pressure region during injection.

The injector apparatus may further comprise a pump operable to supply fluid to the low pressure chamber from the low pressure region. The pump may be operable to supply fluid to the low pressure chamber from the low pressure region prior to injection.

The first piston may be freely moveable relative to the body. In such embodiments, the first piston is moved towards and away from the associated chamber during use due to pressure imbalances above and below the first piston. Alternatively, the injector apparatus may further comprise a return spring configured to bias the first piston towards the associated chamber during use. In this manner, it can be possible to supply the injector apparatus with fluid even when the pressure in the combustion chamber is higher than on the opposite side of the first piston. This can provide greater flexibility in the amount and timing of a flow of low pressure fluid into the injector apparatus for cooling during operation.

According to an aspect of the present invention there is provided an injector apparatus for injecting fluid under pressure into an associated chamber, the apparatus including a body, a first piston moveable in the body, the first piston defining a first working area facing an associated chamber, a high pressure piston defining a high pressure working area facing a high pressure chamber, the first working area being greater than the high pressure working area, the first piston being operable to compress fluid in the high pressure chamber using the high pressure piston, the injector apparatus further including an accumulator, the high pressure chamber being operable to pressurise the accumulator with fluid and the accumulator being operable to supply fluid under pressure through an injector orifice into an associated chamber.

With this arrangement, the injector apparatus is operable to generate very high injection pressures using the pressure within the combustion chamber without the need for an external high pressure pump. Further, by providing an accumulator which is pressurised with fluid by the high pressure chamber and is operable to supply fluid under pressure through the injector orifice, the available injection pressure for the next engine cycle is increased. This allows greater flexibility in deciding the optimal injection timing while maintaining maximum potential injection pressure. The accumulator provides the freedom to adjust injection timing whilst maintaining an injection pressure which would not otherwise be achievable. The accumulator also serves to damp out the highly dynamic changes in fluid pressure that might otherwise be seen in the injector.

The injector apparatus may further comprise one or more check valves located between the accumulator and the high pressure chamber.

The one or more check valves may be configured to allow fluid flow in a first direction from the high pressure chamber to the accumulator and to restrict or prevent fluid flow in a second direction from the accumulator to the high pressure chamber.

The accumulator may be located downstream of the high pressure chamber and upstream of the injector orifice.

The injector apparatus may further comprise a refill port by which the high pressure chamber is refilled with fluid during operation. The accumulator may be located downstream of the refill port and upstream of the injector orifice.

The accumulator may have a maximum volume of from 7 to 700 times the maximum volume of the high pressure chamber. The accumulator may have a maximum volume of from 10 to 100 times the maximum volume of the high pressure chamber. The accumulator may have a maximum volume of from 20 to 30 times the maximum volume of the high pressure chamber.

The accumulator may have a maximum volume of from 2 to 20 cc. The accumulator may have a maximum volume of from 5 to 10 cc.

The accumulator may comprise one or more moveable components by which the volume of the accumulator may be varied. The volume of the accumulator may be constant.

The injector apparatus may further comprise a control chamber, wherein movement of the first piston is selectively controllable by controlling the fluid in the control chamber. The

T The injector apparatus may further comprise a valve seat and a valve member selectively operable to engage the valve seat to operably isolate the high pressure chamber from the injector orifice and selectively operable to disengage the valve seat to fluidly connect the high pressure chamber with the injector orifice.

The control chamber may be partially defined by the valve member.

The injector apparatus may further comprise a control chamber vent valve operable to vent the control chamber to a low pressure region.

The injector apparatus may be configured so that operating the control chamber vent valve to vent the control chamber to a low pressure region allows the valve member to disengage the valve seat.

The control chamber may be fluidly coupled with the accumulator.

The injector apparatus may further comprise a restrictor having a restrictor orifice by which the control chamber is fluidly coupled with the accumulator.

The restrictor orifice may be configured to generate a pressure differential between the control chamber and the accumulator when the control chamber vent valve is operated to vent the control chamber to a low pressure region.

The lower pressure region may be a tank or reservoir. The lower pressure region may be configured to store fluid to be injected. The lower pressure region may contain fluid to be injected. The lower pressure region may be open to the atmosphere.

The accumulator may have a maximum volume of from 400 to 4000 times the maximum volume of the control chamber. The accumulator may have a maximum volume of from 1000 to 2000 times the maximum volume of the control chamber. The accumulator may have a maximum volume of from 1200 to 1600 times the maximum volume of the control chamber.

The injector apparatus may further comprise a nozzle chamber directly upstream of the injector orifice, wherein the accumulator is operable to supply fluid under pressure through the injector orifice via the nozzle chamber.

The accumulator may have a maximum volume of from 2 to 20 times the maximum volume of the nozzle chamber. The accumulator may have a maximum volume of from 5 to 10 times the maximum volume of the nozzle chamber.

The accumulator may comprise an accumulator chamber defined within the body of the injector.

The accumulator chamber may be concentric with the injector orifice. The accumulator chamber may be offset from a central axis of the injector orifice.

The accumulator may be external to the body of the injector.

The accumulator may be operable to supply fluid under pressure through the injector orifice of the injector apparatus into an associated chamber of the injector apparatus.

The accumulator may be operable to supply fluid under pressure through an injector orifice of a further injector apparatus into an associated chamber of the further injector apparatus.

The high pressure piston may be annular.

The first piston may be concentric with the high pressure piston.

The first piston may comprise the high pressure piston. The piston may be unitary with the high pressure piston.

The first piston may be distinct from the high pressure piston. The first piston may be distinct from the high pressure piston and connected to it by one or more intermediate elements.

The high pressure piston may be cylindrical.

The first piston may define a high pressure bore of the high pressure chamber within which the high pressure piston is positioned.

The high pressure piston may be fixed relative to the body.

The high pressure piston may be moveable relative to the body.

The injector apparatus may further include a low pressure chamber at least partially defined by the first piston and a bore of the body and configured to displace fluid to a low pressure region during injection.

The control chamber may be fluidly connected to the low pressure chamber via a first passage in which a control chamber vent valve is located, the control chamber vent valve being operable to vent the control chamber to the low pressure chamber. For example, the control chamber vent valve may be operable to vent the control chamber to the low pressure chamber in order to initiate fluid injection.

The high pressure chamber may be fluidly connected to the low pressure chamber via a second passage in which an inlet check valve is located, the inlet check valve being configured to permit the supply of fluid to the high pressure chamber from the low pressure chamber via the second passage.

The low pressure chamber may be at least partly defined by an annular bore of the first piston. The low pressure chamber may be at least partly defined by an annular bore in the body of the injector apparatus. The low pressure chamber may be defined by an annular bore of the first piston and by an annular bore in the body of the injector apparatus which are fluidly connected to together define the low pressure chamber.

The injector apparatus may further include a pump operable to supply fluid to the high pressure chamber along a feed line. The pump may be operable to supply fluid from a low pressure region prior to injection.

The injector apparatus may further include a pressure relief valve between the feed line and a low pressure region. The pressure relief valve may be configured to close when the fluid pressure in the feed line is at or below a threshold value. The pressure relief valve may be configured to open to vent fluid from the feed line to the low pressure region when the fluid pressure in the feed line exceeds the threshold value.

The first piston may include the injector orifice through which fluid can be injected into an associated chamber. In other examples, the injector orifice may be provided as part of one or more other components of the injector apparatus. For example, the injector orifice may be provided as part of an injector nozzle forming part of the injector apparatus. The injector nozzle may be connected to the first piston. The injector nozzle may extend through a bore in an end wall of the first piston.

The first piston may be freely moveable relative to the body. In such embodiments, the first piston is moved towards and away from the associated chamber during use due to pressure imbalances above and below the first piston. Alternatively, the injector apparatus may further comprise a return spring configured to bias the first piston towards the associated chamber during use. In this manner, it can be possible to supply the injector apparatus with fluid even when the pressure in the combustion chamber is higher than on the opposite side of the first piston. This can provide greater flexibility in the amount and timing of a flow of low pressure fluid into the injector apparatus for cooling during operation.

According to a further aspect of the invention, there is provided an injector system comprising a first injector apparatus for injecting fluid under pressure into an associated chamber; and a second injector apparatus for injecting fluid under pressure into an associated chamber, wherein each injector apparatus comprises: a body; a first piston moveable in the body, the first piston defining a first working area facing an associated chamber; a high pressure piston defining a high pressure working area facing a high pressure chamber, the first working area being greater than the high pressure working area, the first piston being operable to compress fluid in the high pressure chamber using the high pressure piston; and an injector orifice. The injector system further comprises an accumulator which is common to both of the first and second injector apparatuses, the high pressure chamber of each of first and second injector apparatuses being operable to pressurise the accumulator with fluid. The accumulator is operable to supply fluid under pressure through the injector orifice of the first injector apparatus and through the injector orifice of the second injector apparatus.

According to an aspect of the present invention there is provided a reciprocating internal combustion engine comprising at least one combustion chamber and at least one injector apparatus according to any preceding aspect, the at least one injector apparatus being configured to inject fluid under pressure into the at least one combustion chamber.

The invention will now be described, by way of example only, with reference to the accompanying drawings in which:

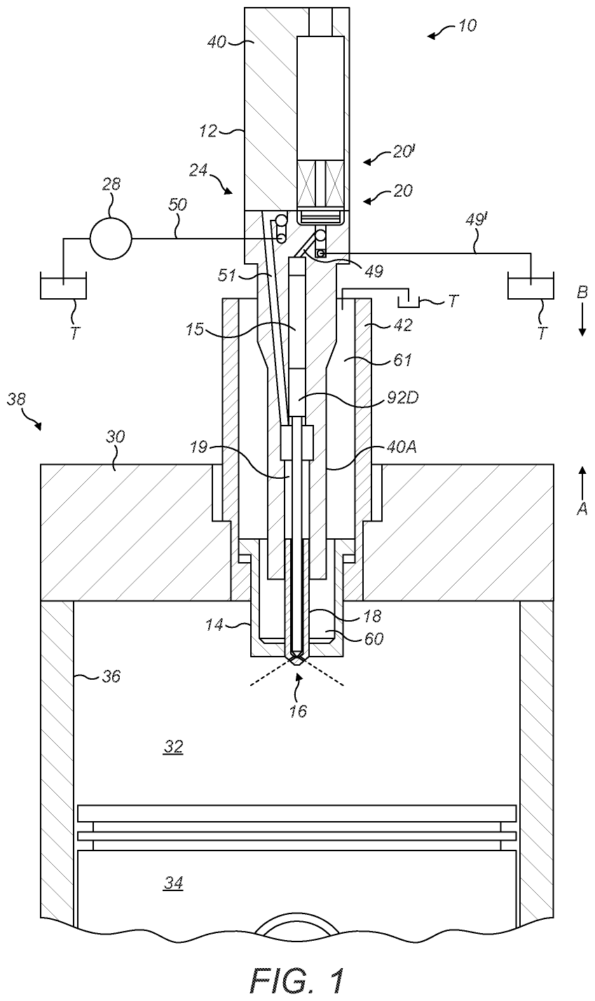

FIG. 1 is a cross section of an injector apparatus according to the present invention,

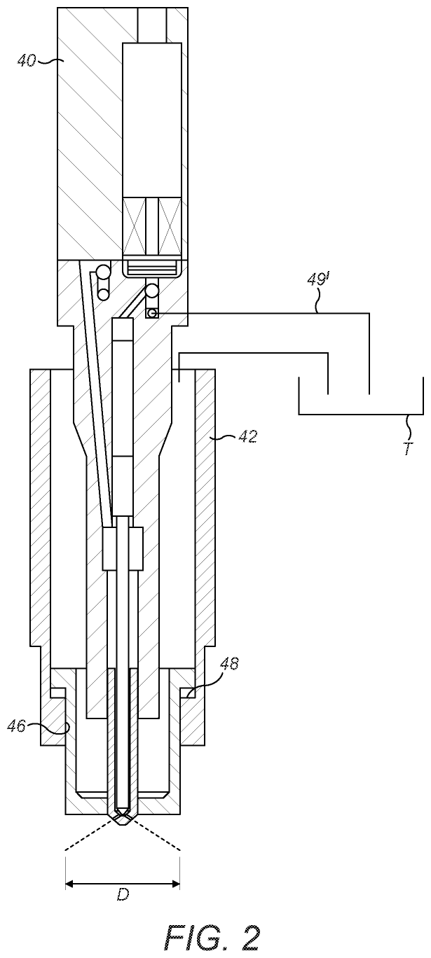

FIG. 2 is an enlarged view of part of FIG. 1,

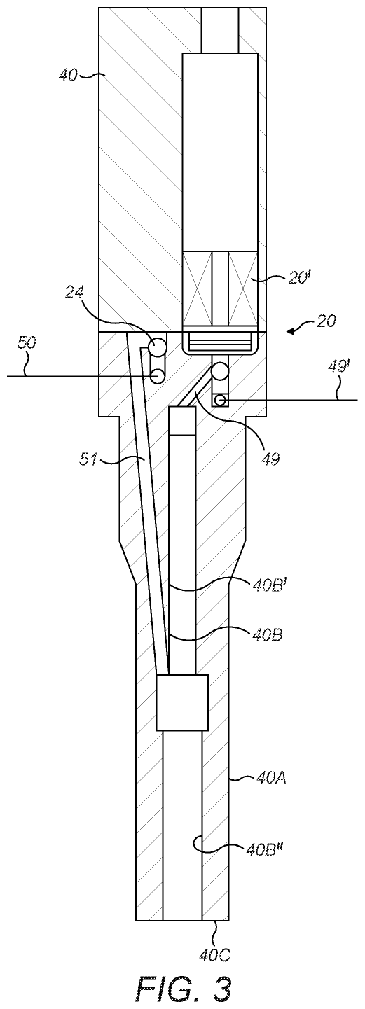

FIGS. 3 to 5 are enlarged views of part of FIG. 2,

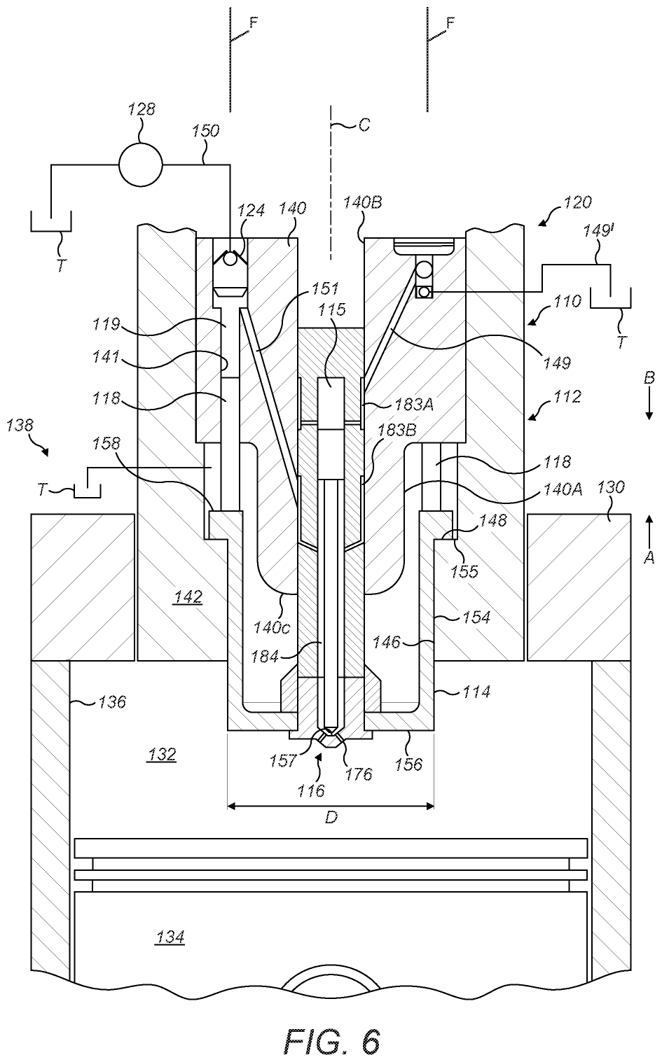

FIG. 6 is a cross-section of an injector apparatus according to the present invention,

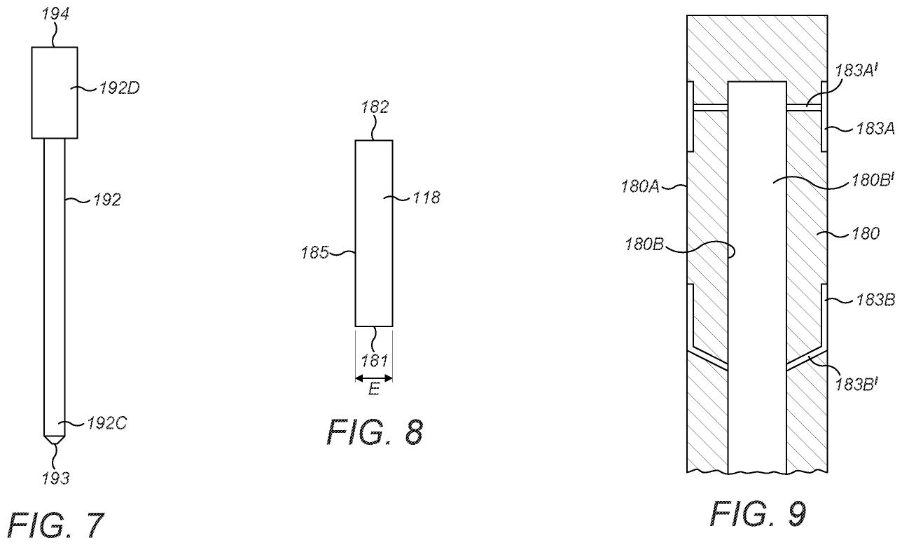

FIGS. 7 to 9 are enlarged views of parts of FIG. 6, and

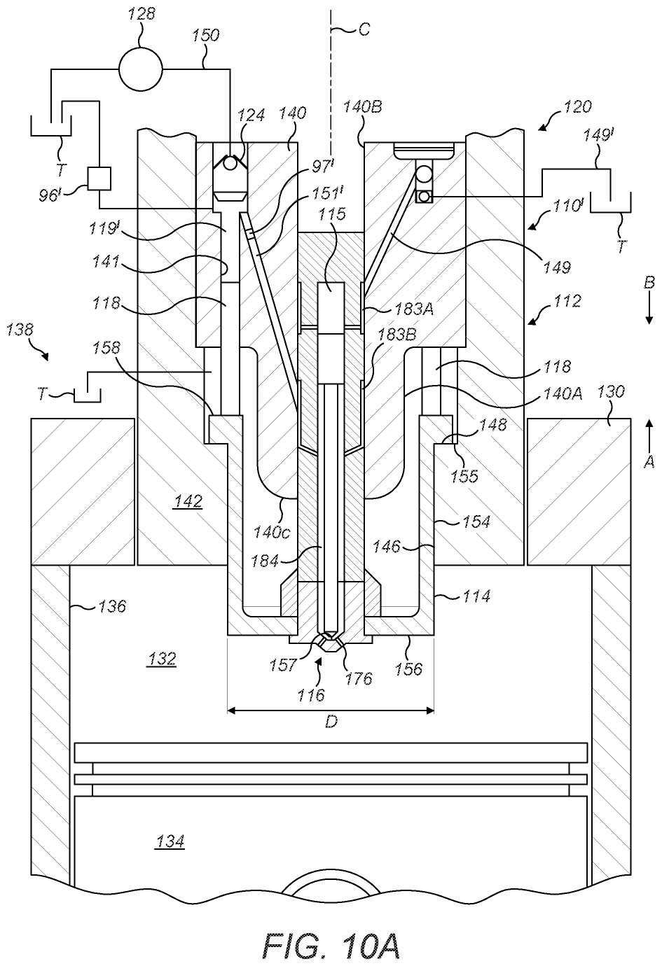

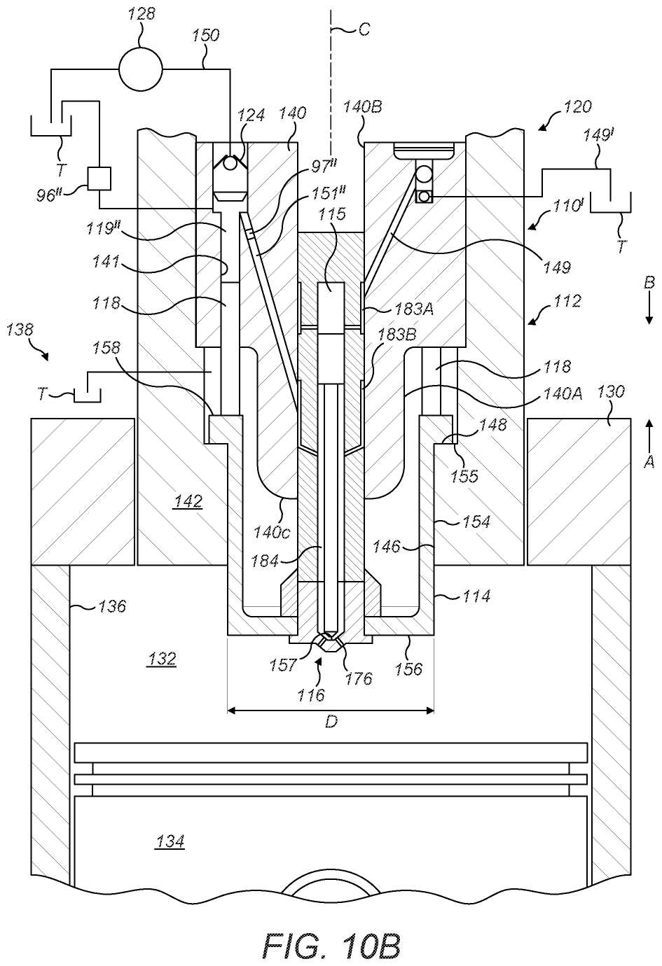

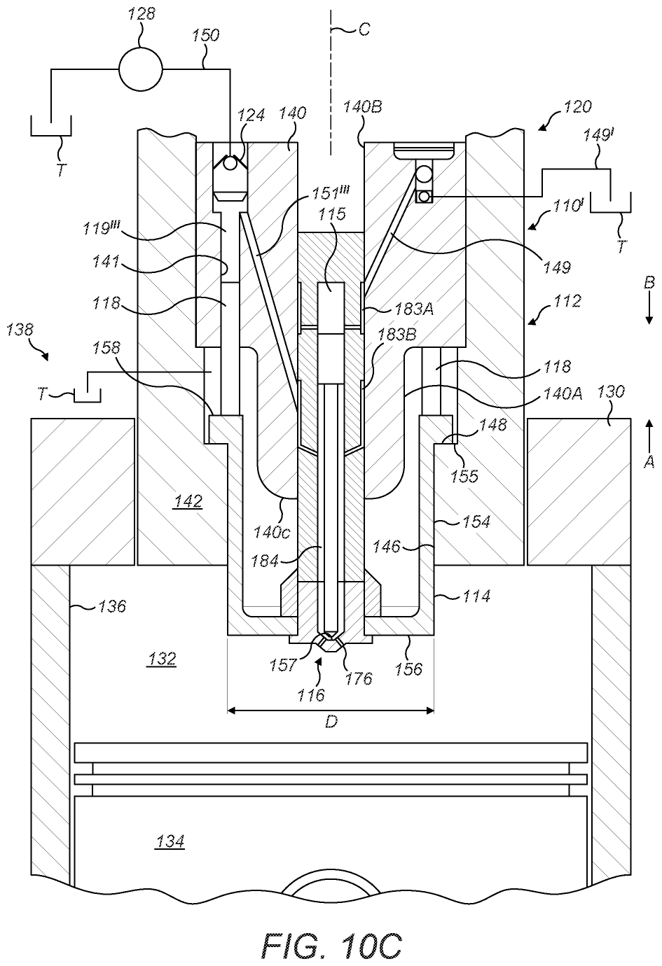

FIGS. 10A to 10C are different cross-sections of an injector apparatus 110′ according to the present invention;

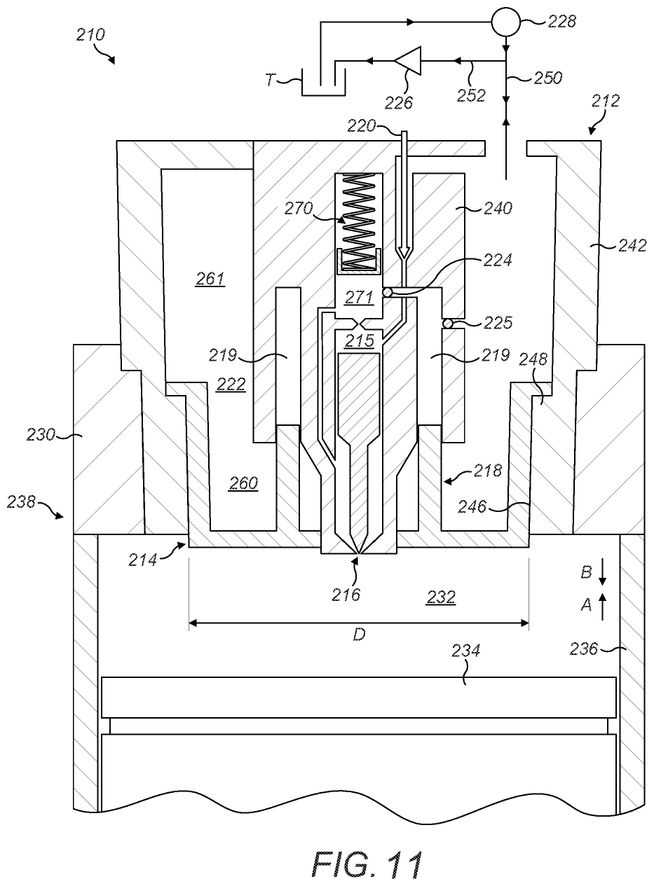

FIG. 11 is a cross-section view of an injector apparatus 210 according to the present invention showing the injector apparatus received in a cylinder head of a reciprocating internal combustion engine;

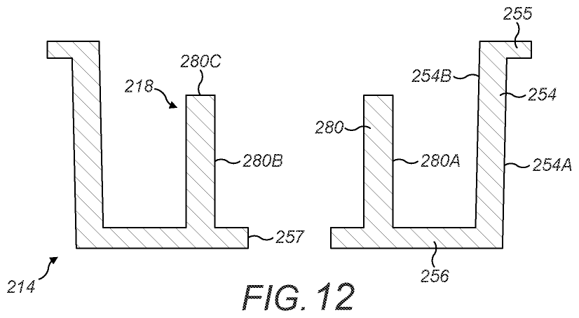

FIG. 12 is an enlarged view of a first piston of the apparatus of FIG. 11;

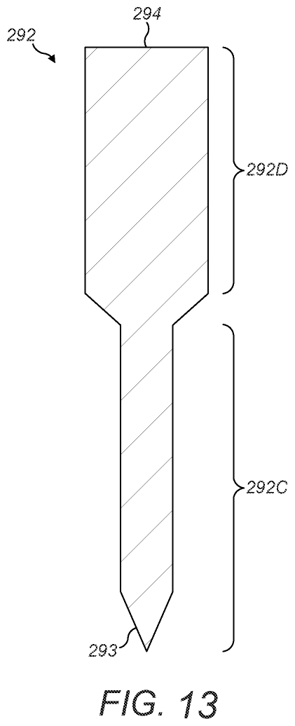

FIG. 13 is an enlarged view of a valve element of the apparatus of FIG. 11;

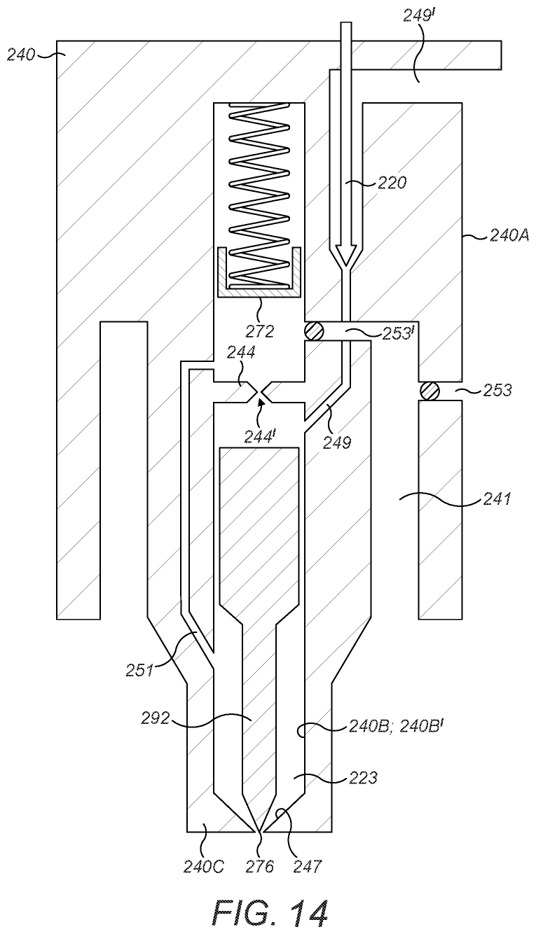

FIG. 14 is an enlarged view of a first part of the body of the injector apparatus of FIG. 11, showing a valve element in a bore of the first part;

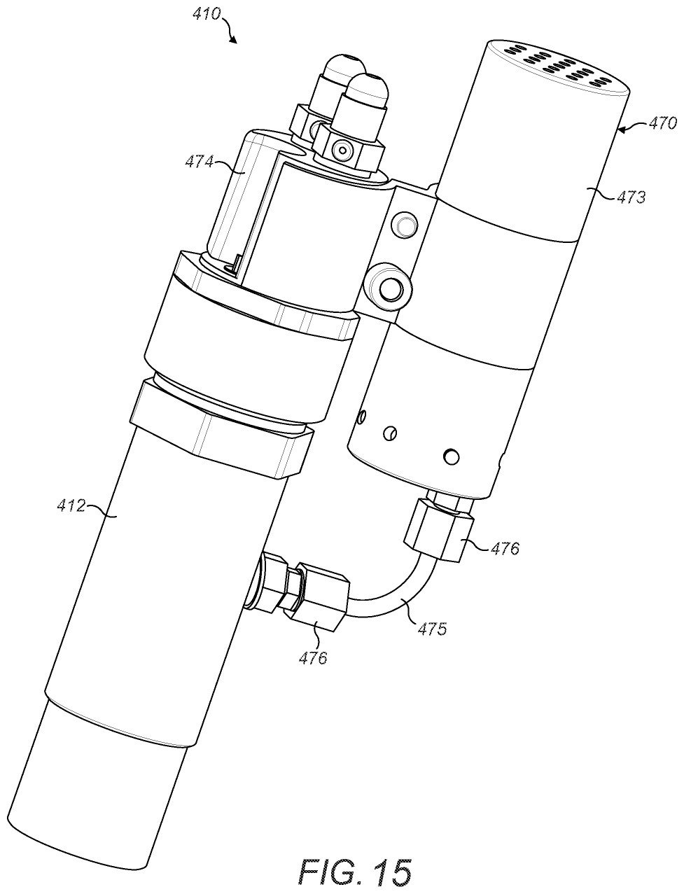

FIG. 15 is a perspective view of an injector apparatus 410 according to the present invention;

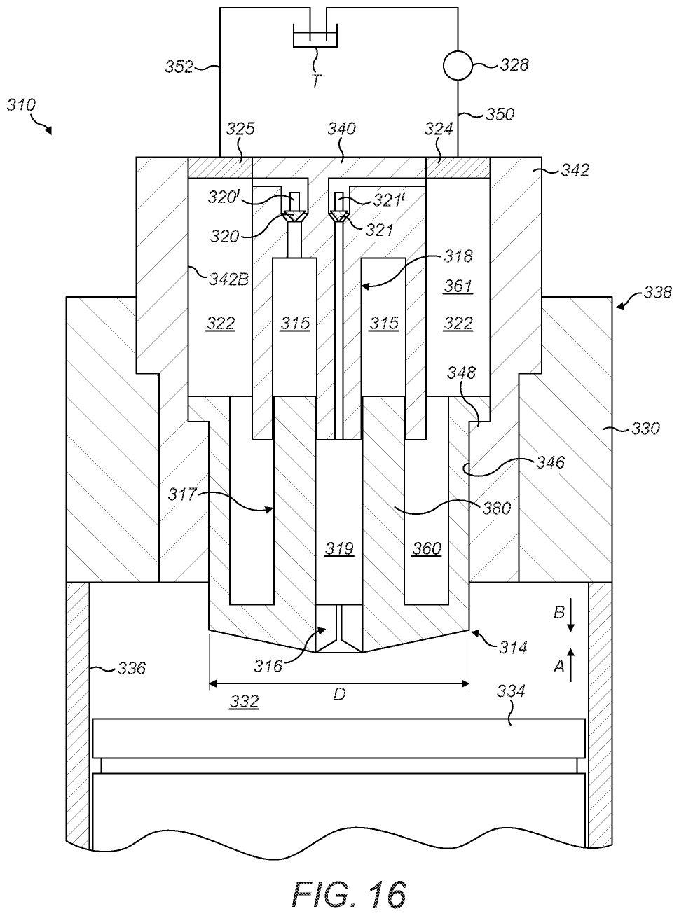

FIG. 16 is a cross-section view of an injector apparatus 310 according to the present invention showing the injector apparatus received in a cylinder head of a reciprocating internal combustion engine;

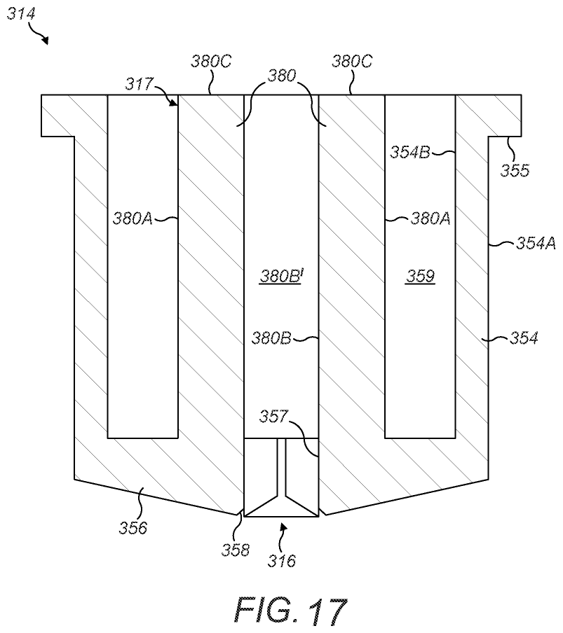

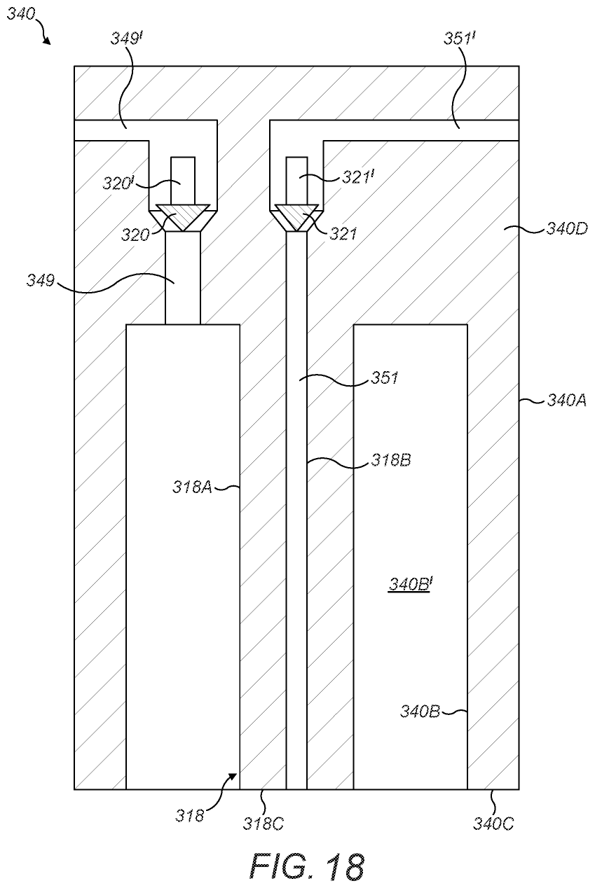

FIG. 17 is an enlarged view of a first piston of the apparatus of FIG. 16;

FIG. 18 is an enlarged view of a first part of the body of the injector apparatus of FIG. 16;

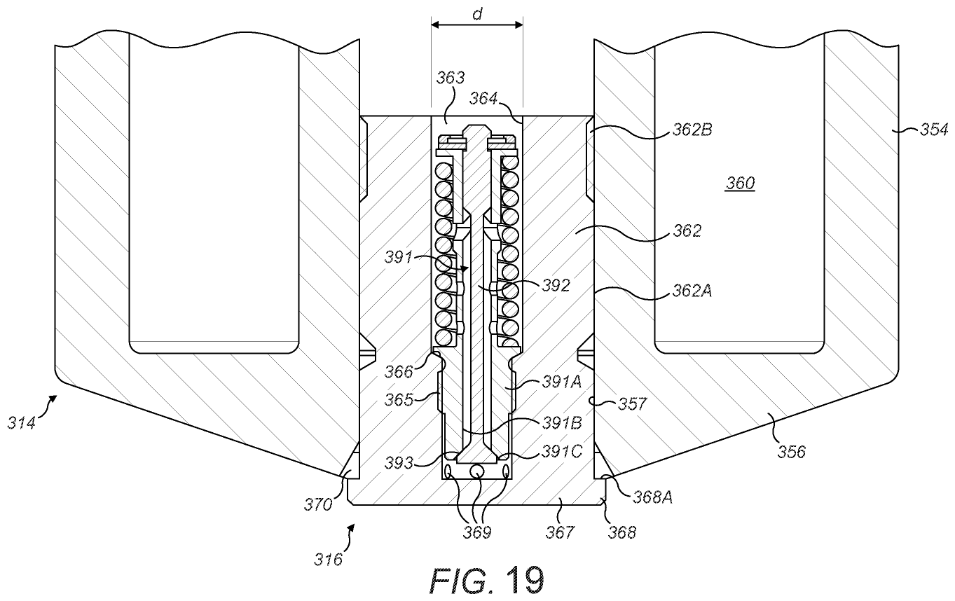

FIG. 19 shows a cross-sectional view of an injector nozzle located in an end wall of the first piston of the injector apparatus of FIG. 16; and

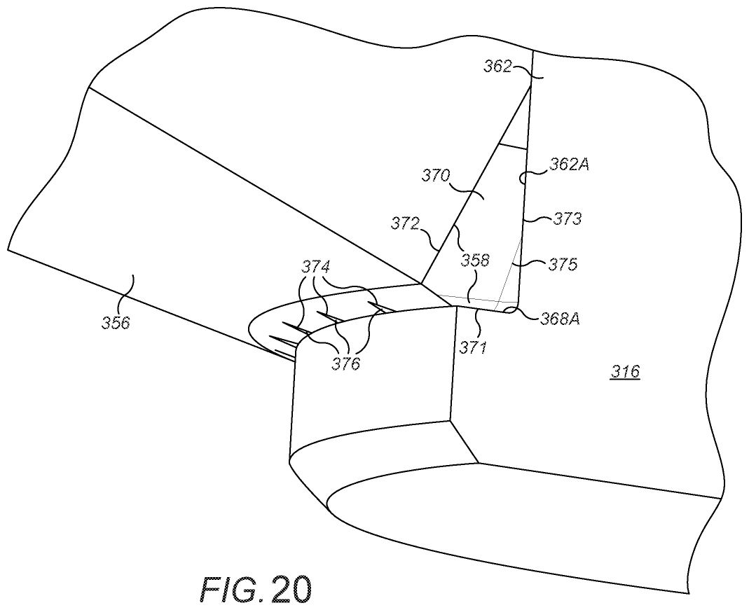

FIG. 20 is a further view of the injector nozzle shown in FIG. 19.

With reference to FIGS. 1 to 5 there is shown an injector apparatus 10 having a body 12, a first piston 14, an injector nozzle 16, and a second piston 18.

The injector apparatus further includes a control volume vent valve 20.

In use, the injector apparatus is attached to a cylinder head 30 (shown schematically) or the like with the nozzle being configured to inject fluid into an associated chamber 32, such as an internal combustion chamber. The associated chamber 32 varies in volume as a piston 34 reciprocates within a cylinder 36 of an internal combustion engine 38.

In use, a pump 28 may be connected to a low pressure region, in this case to a tank T. The tank T may supply fluid to the pump 28 and may also receive fluid from the injector apparatus as will be further described below.

The body 12 has a first part 40 and a second part 42. The second part 42 is secured to the first part 40 (details of which are not shown).

The second part 42 includes a bore 46 having an internal diameter D, in one example D=25 mm. The second part 42 has a shoulder 48.

The first part 40 includes a passage 49 being associated with the control volume vent valve 20. First part 40 includes a passage 50 (shown schematically) associated with a check valve 24.

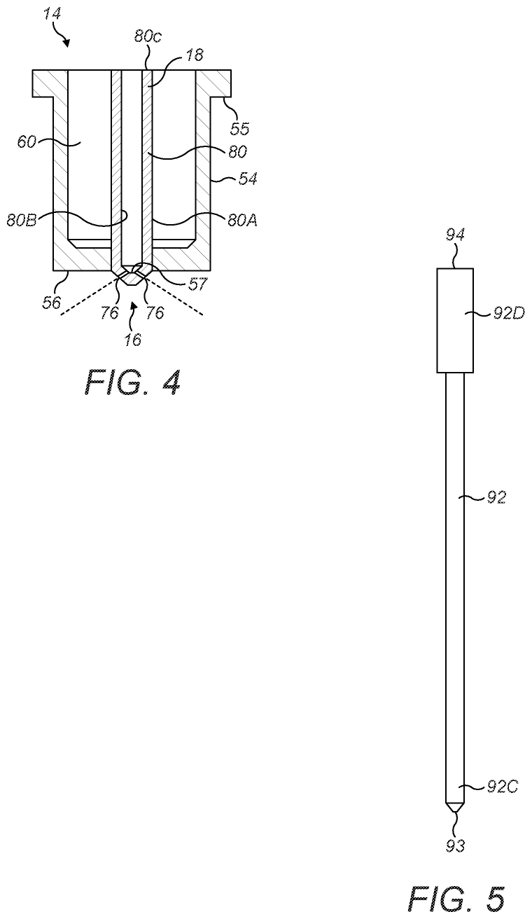

As best seen in FIG. 4, the first piston 14 has a piston wall 54 sized to be a close sliding fit within bore 46 of the second part 42 so as to essentially seal the wall 54 with the bore 46. The first piston 14 includes a shoulder 55 and an end wall 56 having injector nozzle 16. The end wall 56 defines a valve seat 57.

The injector nozzle 16 includes a plurality of injector orifices 76.

Unitarily formed with the first piston 14 is a high pressure piston 18. High pressure piston 18 depends upwardly from end wall 56 of the first piston 14 and is cylindrical having a stem 80 with an outer surface 80A, an inner surface 80B and an end surface 80C. End surface 80C is annular and defines the high pressure working area, as will be further described below.

First part 40 is generally elongate and includes an outer surface 40A, an inner surface 40B and an end surface 40C.

A valve element 92 is generally elongate and includes a first end 92C and a second end 92D. The diameter of the first end 92C is smaller than the diameter of the second end 92D.

First end 92C defines a valve surface 93 selectively engageable with and selectively disengageable from the valve seat 57, as will be further described below.

Second end 92D is received in a bore 40B′ defined by inner surface 40B. The sizing of the second end 92D and bore 40B′ is such that the valve element 92 is a sliding fit within the bore 40B′, the sizing being such as to allow a small amount of fluid to pass from the high pressure chamber 19 to the control chamber 15 (as will be further discussed below). Thus, the valve element 92 can slide axially relative to the bore 40B′.

Outer surface 80A is received in bore 40B″ defined by inner surface 40B. The sizing of outer surface 80A and bore 40B″ in such as to create a close sliding fit so as to essentially seal outer surface 80A with the bore 40B″.

As best seen in FIG. 1, the second end 92D is positioned part way along bore 40B′ thereby defining a control volume 15 above second end 92D and a high pressure chamber 19 generally below the second end 92D.

The control chamber 15 is generally cylindrical and is defined by end surface 94 of second end 92D and part of inner surface 40B. At an end of the control chamber 15 opposite end surface 94 is passage 49 which fluidly connects control chamber 15 to the control volume vent valve 20.

The high pressure chamber 19 is connected via a passage 51 to the check valve 24. Passage 50 is connected to the “upstream” side of check valve 24.

A solenoid 20′ can be used to open the control volume vent valve 20 thereby connecting passage 49 to passage 49′ which in turn is connected to tank T. Deactivation of the solenoid 20′ causes the control volume vent valve 20 to close thereby isolating passage 49 from passage from 49′.

The first end 92C of the valve element 92 is sized so as to create a clearance between the first end 92C and the inner surface 80B thereby allowing fluid from the high pressure chamber 19 to pass through the centre of the high pressure piston 18 to the injection orifices 76 and into the combustion chamber or the like as will be further described below.

As best seen in FIG. 1, a portion of outer surface 40A proximate end surface 40C is received within an upper portion of the first piston 14. However, as can be seen, there is a clearance between lower portion of outer surface 40A and the first piston 14.

The first piston defines a region 60. The first part 40 and second part 42 of the body define a region 61. Region 61 is fluidly connected to tank T (shown schematically). As such, region 60 is also fluidly connected to tank via region 61.

Operation of the injector apparatus is as follows:

Prior to injection the control chamber 15, high pressure chamber 19, region 60, region 61 are all primed with fluid supplied via pump 28. The fluid is at relatively low pressure (e.g. 3-5 bar). The first piston 14 is in its lowermost position (when considering FIG. 1) such that shoulder 55 of the first piston 14 is in engagement with shoulder 48 of the body. The valve element 92 is also in its lowermost position such that valve surface 93 is in engagement with valve seat 57 thereby isolating the orifices 76 from the high pressure chamber 19. Control volume vent valve 20 is closed. Check valve 24 is closed.

As the piston 34 ascends within cylinder 36 during the compression stroke of the internal combustion engine 38, pressure is developed within the combustion chamber 32. This increasing pressure acts on the first working area of the first piston i.e. the area defined by diameter D of the first piston, i.e. an area equal to piD/4². Thus the increase in pressure within the the combustion chamber 32 creates a force on the first piston 14 in the direction of arrow A. However, the first piston does not move in the direction of arrow A because the upward force on piston 14 is resisted by fluid within the high pressure chamber 19 being hydraulically locked (by virtue of check valve 24) and hence causing a reaction force in direction B on the end surface 80C of stem 80 of the high pressure piston 18. The effective area of the high pressure piston is therefore the area of the end surface 80C, i.e. pi (outer surface 80A diameter−inner surface 80B diameter)²/4. The upward force on piston 14 also resisted by fluid within the control chamber 15 being hydraulically locked (by virtue of control volume vent valve 20 being closed) and hence causing a reaction force in direction B on end surface 94 of the valve member 92 which in turn acts on valve seat 57 via valve surface 93. Note that since regions 60 and 61 are connected to tank, no reaction force can be provided by fluid within these regions of the injector apparatus.

As will be appreciated, the effective area of the high pressure piston is significantly smaller than the effective area of the first piston 14, and as such the pressure within the high pressure chamber will be greater than the pressure created in the combustion chamber 32 of the internal combustion engine. This allows extremely high injection pressures e.g. above 3000 bar.

In order to start injection, a control system (not shown) causes the control volume vent valve 20 to open e.g. by powering the solenoid 20′. This fluidly connects passage 49 to passage 49′, and hence fluidly connects the control chamber 15 to tank T. Thus, the pressure in the control chamber falls but the pressure in the high pressure chamber remains relatively high thereby causing the valve member 92 to move in the direction of arrow A, i.e. upwardly when viewing FIG. 1 so as to disengage the valve surface 93 from the valve seat 57 thereby fluidly connecting the high pressure chamber 19 with the injector orifices 76. This allows the fluid within the high pressure chamber to be injected through the orifices 76 into the internal combustion chamber, thereby initiating combustion. As fluid is injected, the first piston progressively moves in the direction of arrow A, i.e. rises when viewing FIG. 1. However, because pressure in the high pressure chamber is higher than pressure in the control chamber, the valve element 92 can continue to rise as fluid from the control chamber is vented to tank. In this manner, during injection, it is possible to ensure that the valve surface 93 of the valve element 92 remains disengaged from the valve seat 57 of the first piston.

In order to stop injection the control volume vent valve 20 is closed thereby isolating passage 49 from passage 49′ and hence isolating the control chamber from tank T. The control chamber is then hydraulically locked. This prevents any further upward movement of the valve element 92. However, continued movement of first piston upwardly will cause the valve seat 57 of the first piston to move into engagement with the now stationary valve surface 93 of the valve element 92 thereby isolating the injector orifices from the high pressure chamber 19 whereupon injection ceases.

Note that even though injection has stopped, the high pressure chamber remains pressurised by virtue of the pressure within the combustion chamber 32. Injection typically occurs towards the end of a compression stroke and/or at the start of a combustion (expansion) stroke. Because the high pressure chamber remains pressurised at the end of injection, further injection is possible during the particular compression/combustion stroke. Such “double” injection is referred to as “double strike” injection. As will be appreciated, the present invention allows for two or more distinct injections (i.e. multi-strike injection) to occur during a single compression/combustion stroke.

Once injection for a particular compression/combustion stroke has finally stopped, the pressure within the combustion chamber will fall significantly, typically when an exhaust valve or valves are opened, and consequently the pressure within the high pressure chamber 19 will also fall significantly. The pressure within the combustion chamber 32 will remain at a relatively low pressure during an exhaust stroke and during an inlet stroke. At some time during the time period when the pressure in the combustion chamber is relatively low the injector apparatus will be reprimed with fuel in time for the next injection event which will occur at the next compression/combustion stroke.

Thus, the control volume vent valve 20 is closed and the pump 28 provides pressurised fluid (e.g. at around 3-5 bar) which flows past the check valve 24, through passage 51 and into the high pressure chamber 19. As mentioned above, the sizing of the second end 92D and bore 40B′ is such as to allow some fuel to pass from the high pressure chamber 19 to the control chamber 15, thereby allowing the pressure in the control chamber to equalise with the pressure in the high pressure chamber. This causes the valve member 92 to be biased downwards in the direction of arrow B which in turn causes the first piston to be biased downwards via virtue of engagement between valve surface 93 and valve seat 57. Note the sizing of the second end 92D and bore 40B′ is such as to create a restrictive orifice which allows the above mentioned repriming of the injector, but does not significantly affect the injection of fuel from the high pressure chamber through the injector orifice 76 into the combustion chamber. In further embodiments the restrictive orifice could be created by an alternative arrangement.

With reference to FIGS. 6 to 9 there is shown an injector apparatus 110 having a body 112, a first piston 114, an injector nozzle 116, and second pistons 118.

The injector apparatus further includes a control volume vent valve 120.

In use, the injector apparatus is attached to a cylinder head 130 (shown schematically) or the like with the nozzle being configured to inject fluid into an associated chamber 132, such as an internal combustion chamber. The associated chamber 132 varies in volume as a piston 34 reciprocates within a cylinder 136 of an internal combustion engine 38.

In use, a pump 128 may be connected to a tank T. The tank T may supply fluid to the pump 128 and may also receive fluid from the injector apparatus as will be further described below.

The body 112 has a first part 140 and a second part 142. The second part 142 is secured to the first part 140.

The second part 142 includes a bore 146 having an internal diameter D, in one example D=25 mm. The second part 142 has a shoulder 148.

The first part 140 includes a passage 149 being associated with the control volume vent valve 120. First part 140 includes a passage 150 (shown schematically) associated with a check valve 124.

The first piston 114 has a piston wall 154 sized to be a close sliding fit within bore 146 of the second part 142 so as to essentially seal the wall 154 with the bore 46. The first piston 114 includes a shoulder 155 and an end wall 156 having injector nozzle 116. The end wall 156 defines a valve seat 157.

The injector nozzle 16 includes a plurality of injector orifices 176.

In this case there are three high pressure pistons 118 (each having an axis F), only two of which can be seen in FIG. 6. The three high pressure pistons are equi-spaced around an axis C of the injector apparatus 110 and are identical. Each high pressure piston is elongate having a diameter E (which defines a surface 185), a first end surface 181 and a second end surface 182. Each high pressure piston is slideable within a corresponding bore 141 of the first part 140. The sizing of diameter E and associated bore 141 is such as to create a close sliding fit so as to essentially seal surface 185 with bore 141. Each end surface 181 engages a surface 158 of the first piston 114. Each second end surface 182 and associated bore 141 define a high pressure chamber 119. Collectively the three second end surfaces 182 define the high pressure working area as will be described below.

First part 140 includes an outer surface 140A, an inner surface 140B and an end surface 140C.

Attached to first piston 114 is a stem 180 which depends upwardly when viewing FIG. 6. The stem 180 is cylindrical with an outer surface 180A and inner surface 180B defining a bore 180B′ The outer surface 180A includes a circular groove 183A and a circular groove 183B. Passage 183A′ fluidly connects groove 183A to inner surface 180B and passage 183B′ fluidly connects groove 183B to inner surface 180B.

A valve element 192 is generally elongate and includes a first end 192C and a second end 192D. The diameter of the first end 192C is smaller than the diameter of the second end 192D.

First end 192C defines a valve surface 193 selectively engageable with and selectively disengageable from the valve seat 157, as will be further described below.

Second end 192D is received in a bore 180B′ defined by inner surface 180B. The sizing of the second end 192D and bore 180B′ is such that the valve element 192 is a sliding fit within the bore 180B′, the sizing being such as to allow a small amount of fluid to pass from region 184 to the control chamber 115. Thus, the valve element 192 can slide axially relative to the bore 180B′.

As best seen in FIG. 6, the second end 192D is positioned part way along bore 180B′ thereby defining a control volume 115 above second end 192D and a region 184 generally below the second end 192D.

The control chamber 115 is generally cylindrical and is defined by end surface 194 of second end 192D and part of inner surface 180B. At an end of the control chamber 115 opposite end surface 194 is passage 149 which fluidly connects control chamber 115 to the control volume vent valve 120.

Each high pressure piston faces a check valve 124 (only one of which is shown). Passages 150 are connected to the “upstream” side of check valves 124.

A solenoid 120′ can be used to open the control volume vent valve 120 thereby connecting passage 149 to passage 149′ which in turn is connected to tank T. Deactivation of the solenoid 120′ causes the control volume vent valve 120 to close thereby isolating passage 149 from passage from 149′.

The first end 192C of the valve element 192 is sized so as to create a clearance between the first end 192C and the inner surface 180B thereby allowing fluid from each high pressure chamber 119 to pass through corresponding passages 151, circular groove 183B, passages 183B′, region 184 to the injection orifices 176 and into the combustion chamber or the like as will be further described below.

As best seen in FIG. 6, a portion of outer surface 140A proximate end surface 140C is received within an upper portion of the first piston 114. However, as can be seen, there is a clearance between lower portion of outer surface 140A and the first piston 114.

The first piston defines a region 160. Region 160 is fluidly connected to tank T (shown schematically).

Operation of the injector apparatus is as follows:

Prior to injection the control chamber 115, high pressure chambers 119, and region 160, are all primed with fluid supplied via pump 28. The fluid is at relatively low pressure (e.g. 3-5 bar). The first piston 114 is in its lowermost position (when considering FIG. 6) such that shoulder 155 of the first piston 114 is in engagement with shoulder 148 of the body. The valve element 192 is also in its lowermost position such that valve surface 193 is in engagement with valve seat 157 thereby isolating the orifices 176 from the high pressure chambers 119. Control volume vent valve 120 is closed. Check valves 124 are all closed.

As the piston 134 ascends within cylinder 136 during the compression stroke of the internal combustion engine 138, pressure is developed within the combustion chamber 132. This increasing pressure acts on the first working area of the first piston i.e. the area defined by diameter D of the first piston, i.e. an area equal to piD²/4. Thus the increase in pressure within the the combustion chamber 132 creates a force on the first piston 114 in the direction of arrow A. However, the first piston does not move in the direction of arrow A because the upward force on piston 114 is resisted by fluid within the three high pressure chambers 119 being hydraulically locked (by virtue of check valves 124) and hence causing a reaction force in direction B on the shoulder 158 of the first piston. The collective effective area of the three high pressure piston is therefore the total area of the second end surfaces 182 i.e. 3 piE²/4. Note that since the control chamber is defined by components that are fixed relative to the first piston no reaction force is provided by fluid in the control chamber. Note that since regions 160 and 161 are connected to tank, no reaction force can be provided by fluid within these regions of the injector apparatus.

As will be appreciated, the collective effective area of the three high pressure piston is significantly smaller than the effective area of the first piston 114, and as such the pressure within the high pressure chambers will be greater than the pressure created in the combustion chamber 132 of the internal combustion engine. This allows extremely high injection pressures e.g. above 3000 bar.

In order to start injection, a control system (not shown) causes the control volume vent valve 120 to open e.g. by powering the solenoid 120′. This fluidly connects passage 149 to passage 149′, and hence fluidly connects the control chamber 115 to tank T. Thus, the pressure in the control chamber falls but the pressure in the high pressure chamber remains relatively high thereby causing the valve member 92 to move in the direction of arrow A, i.e. upwardly when viewing FIG. 6 so as to disengage the valve surface 193 from the valve seat 157 thereby fluidly connecting the high pressure chamber 119 with the injector orifices 176. This allows the fluid within the high pressure chambers to be injected through the orifices 176 into the internal combustion chamber, thereby initiating combustion. As fluid is injected, the first piston progressively moves in the direction of arrow A, i.e. rises when viewing FIG. 6. Because the valve surface 193 has disengaged the valve seat 157 and because as the first piston moves upwardly the control chamber also moves upwardly then it is not necessary to continue to vent the control chamber during injection. In this manner, during injection, it is possible to ensure that the valve surface 193 of the valve element 192 remains disengaged from the valve seat 157 of the first piston.

In order to stop injection the control volume vent valve 120 is closed thereby isolating passage 149 from passage 149′ and hence isolating the control chamber from tank T. The pressure in the control chamber is then equalised with the pressure in region 184 (and hence equalised with the pressure in the high pressure chamber 119) by virtue of fluid passing from region 184 past end 192D into the control chamber 115. This causes the valve member to move in the direction of arrow B relative to the first piston thereby causing the valve surface 93 to engage the valve seat and isolate the high pressure chambers 119 from the injector orifices 176 whereupon injection ceases.

Note that even though injection has stopped, the high pressure chamber remains pressurised by virtue of the pressure within the combustion chamber 132. Injection typically occurs towards the end of a compression stroke and/or at the start of a combustion (expansion) stroke. Because the high pressure chamber remains pressurised at the end of injection, further injection is possible during the particular compression/combustion stroke. Such “double” injection is referred to as “double strike” injection. As will be appreciated, the present invention allows for two or more distinct injections (i.e. multi-strike injection) to occur during a single compression/combustion stroke.

Once injection for a particular compression/combustion stroke has finally stopped, the pressure within the combustion chamber will fall significantly, typically when an exhaust valve or valves are opened, and consequently the pressure within the high pressure chamber 119 and region 184 will also fall significantly. The pressure within the combustion chamber 132 will remain at a relatively low pressure during an exhaust stroke and during an inlet stroke. At some time during the time period when the pressure in the combustion chamber is relatively low, the injector apparatus will be reprimed with fuel in time for the next injection event which will occur at the next compression/combustion stroke.

Thus, the control volume vent valve 120 is closed and the pump 128 provides pressurised fluid (e.g. at around 3-5 bar) which flows past the check valve 124, through passage 151 and into region 184. As mentioned above, the sizing of the second end 192D and bore 180B′ is such as to allow some fuel to pass from region 184 to the control chamber 115, thereby allowing the pressure in the control chamber to equalise with the pressure in region 184 and hence the pressure in the high pressure chamber 119. This causes the valve member 192 to be biased downwards in the direction of arrow B which in turn causes the first piston 114 to be biased downwards via virtue of engagement between valve surface 193 and valve seat 157. As the first piston 114 descends, then so do the high pressure pistons 118 and the high pressure chambers 119 are consequently refilled with fuel from pump 128 coming via check valve 124.

Note the sizing of the second end 192D and bore 180B′ is such as to create a restrictive orifice which allows the above mentioned repriming of the injector apparatus 110 but not so as to significantly affect the injection of fuel from the high pressure chambers 119 through the injector orifice 176 into the combustion chamber 132. In further embodiments the restrictive orifice could be created by an alternative arrangement.

FIGS. 10A to 10C show a variant of an injector assembly apparatus 110′ which is the same as injector apparatus 110 except that associated with two of the high pressure chambers 119′ and 119″ are associated vent valves 96′ and 96″ (shown schematically) and associated check valves 97′ and 97″ (shown schematically).

Check valve 97′ is positioned in passage 151′ and check valve 97″ is positioned in passage 151″. Note there are no check valves in passage 151′″. Check valve 97′ and 97″ allow fluid to flow from the high pressure chamber 119′ and 119″ to the region 184 but prevent reverse flow through passage 151′ and 151″.

Vent valves 96′ and 96″ can be selectively independently opened thereby connecting high pressure chambers 119′ and 119″ with tank T. Vent valves 96′ and 96″ can be selectively independently closed, thereby isolating the high pressure chamber 119′ and 119″ from tank.

The injector apparatus 110′ allows the ratio of [the effective areas of the high pressure pistons] to [effective area of the first piston] to be varied.

In a first configuration vent valves 96′ and 96″ are closed. Under these circumstances the injector apparatus 110′ operates as described above with respect to injector apparatus 110. In particular the collective effective area of the three high pressure pistons is the total area of the second end surfaces 182 i.e. 3piE²/4.

In a second configuration, vent valve 96′ is open and vent valve 96″ is closed. As such, high pressure chamber 119′ cannot generate any pressure and is therefore “disabled”. Under these circumstances the high pressure working area is reduced from 3piE²/4 down to 2piE²/4. As such, the pressure in the high pressure chambers 119″ and 119′″ is increased.

In a third configuration vent valve 96′ and 96″ are both opened and under these circumstances high pressure chambers 119′ and 119″ are unable to generate any pressure and hence are both “disabled”. As such, the high pressure working area is further reduced to piE²/4 and the pressure is high pressure chamber 119′″ is increased.

Advantageously, by selectively enabling/disabling certain high pressure chambers enables fluid to be injected at different pressures and this is advantageous at certain operating conditions of the associated internal combustion engine.

As described above, the high pressure chambers 119 of FIG. 6 all have the same diameter. Similarly, the high pressure chambers 119′, 119″ and 119′″ of FIGS. 10A to 10C all have the same diameter. In a further embodiment having a plurality of high pressure pistons, the diameter of one of the pistons may differ from the diameter of another of the pistons. In particular, an injector apparatus may have just two high pressure pistons of different diameters, facing associated high pressure chambers. Enabling or disabling the high pressure chambers provides for three high pressure working areas:

a) a first high pressure working area where both high pressure chambers are enabled,

b) a second high pressure working area where one of the high pressure chambers is enabled and the other is disabled, and

c) a third high pressure working area where said one of the high pressure chambers is disabled and said other of the high pressure chambers is enabled.

With reference to FIGS. 11 to 15 there is shown an injector apparatus 210 having a body 212, a first piston 214, an injector nozzle 216, and a second piston 218.

The injector apparatus further includes a control chamber vent valve 220.

In use, the injector apparatus is attached to a cylinder head 230 (shown schematically) or the like with the nozzle being configured to inject fluid into an associated chamber 232, such as an internal combustion chamber. The associated chamber 232 varies in volume as a piston 234 reciprocates within a cylinder 236 of an internal combustion engine 238.

In use, a pump 228 may be connected to a tank T. The tank T may supply fluid to the pump 228 and may also receive fluid from the injector apparatus as will be further described below.

The body 212 has a first part 240 and a second part 242. The second part 242 is secured to the first part 240 (details of which are not shown).

The second part 242 includes a bore 246 having an internal diameter D, in one example D=25 mm. The second part 242 has a shoulder 248.

The first part 240 includes a line 250 (shown schematically) associated with a pressure relief valve 226 on a return line 252 and with the pump 228.

As best seen in FIG. 12, the first piston 214 has a piston wall 254 sized so that its outer surface 254A is a close sliding fit within bore 246 of the second part 242 so as to essentially seal the wall 254 with the bore 246. Thus, the outer surface 254A has an external diameter which is substantially the same as the internal diameter D of the bore 246. The first piston 214 includes a shoulder 255 and an end wall 256 having a bore 257 through which the end wall 240C of the first part 240 extends. The first piston 214 is slidable within the bore 246 and its lowermost position is defined by engagement of shoulder 255 with the shoulder 248 on the second part 242.

Unitarily formed with the first piston 214 is the second piston 218, or high pressure piston 218. High pressure piston 218 depends upwardly from end wall 256 of the first piston 214 and is cylindrical having a stem 280 with an outer surface 280A, an inner surface 280B and an end surface 280C. End surface 280C is annular and defines the high pressure working area, as will be further described below.

As best seen in FIG. 13, a valve element 292 is generally elongate and includes a first end 292C and a second end 292D. The diameter of the first end 292C is smaller than the diameter of the second end 292D. First end 292C defines a valve surface 293 selectively engageable with and selectively disengageable from the valve seat 247, as will be further described below. Second end 292D defines a second end surface 294 and is received in a bore 240B′ defined by inner surface 240B. The sizing of the second end 292D and bore 240B′ is such that the second end 292D of the valve element 292 is a close sliding fit within the bore 240B′ so as to essentially seal the second end 292D with the bore 240B′ defined by inner surface 240B. The close sliding fit allows the valve element 292 to slide axially relative to the bore 240B′. The valve member 292 is biased towards a closed position, in which the valve surface 293 is engaged with the valve seat 247, by a spring (not shown).

As best seen in FIG. 14, the first part 240 includes a passage 249 associated with the control chamber vent valve 220. First part 240 is generally elongate and includes an outer surface 240A, an inner surface 240B and an end wall 240C defining a valve seat 247 of the injector nozzle. The injector nozzle 216 has one or more orifices 276 formed in the end wall.

The first end 292C of the valve element 292 is sized so as to create a clearance between the outer surface of first end 292C and the inner surface 280B of the first part 240 thereby forming an annular nozzle chamber 223 below the second end 292D, above the valve seat 247 and around the first end 292C. Second end 292D is positioned part way along bore 240B′. A restrictor 244 extends across the bore 240′ above the second end 292D. A control chamber 215 is defined by the region of the bore 240B′ above the second end 292D and below the restrictor 244.

The injector apparatus further includes an accumulator 270 comprising an accumulator chamber 271 which is defined by the region of the bore 240B′ which is above the restrictor 244. The restrictor 244 includes a restriction orifice 244′ by which the control chamber 215 and the accumulator chamber 271 are fluidly coupled. The restrictor 244 thus forms a partial barrier between the control chamber 215 and the accumulator chamber 271. The accumulator chamber 271 is fluidly coupled to the nozzle chamber 223 by a passage 251 which bypasses the control chamber 215. This allows fluid from the accumulator chamber 271 to pass around the second end 292D of the valve element 292 to the nozzle chamber 223 and through injector orifices 276 and into the combustion chamber or the like, as will be further described below. The accumulator chamber 271 has an end wall 272 opposite the restrictor 244. The wall may comprise a flexible diaphragm or may be sprung (as shown in FIGS. 11 and 14). This allows the volume of the accumulator chamber 271 to change and provides a compressive force to fluid stored in the accumulation chamber. Alternatively, the accumulator chamber may comprise a simple, rigid-walled volume which is charged using the elasticity of fluid stored in the accumulator chamber 271. This is possible due to the relatively high compressibility of the fluid, such as diesel fuel, at the high fluid pressures generated during operation of the injector 210.

The stem 280 of the high pressure piston 218 is slidable within an annular bore 241 of the first part 240. The stem 280 is sized so that the outer surface 280A and inner surface 280B of the stem 280 form a close sliding fit within the annular bore 241 so as to essentially seal the stem 280 with the annular bore 241. The annular end surface 280C of the first piston 214 and the annular bore 241 together define a high pressure chamber 219. The close sliding fit between the stem 280 and the side walls of the bore 241 allows the high pressure piston 218 to slide axially relative to the first part 240 to vary the volume of the high pressure chamber 219. The high pressure chamber 219 is fluidly connected to the accumulator chamber 271 by a refill port in the form of a passage 253′ including a check valve 224. The check valve 224 is configured to allow fluid to flow from the high pressure chamber 219 into the accumulator chamber along passage 253′ and to substantially prevent fluid from flowing in the opposite direction. Although only a single check valve 224 is illustrated in FIGS. 11 and 14, the injector apparatus could have any suitable number of check valves between the high pressure chamber 219 and the accumulator chamber 271. For example, the injector apparatus could have two, three, four or five check valves between the high pressure chamber 219 and the accumulator chamber 271.

The first piston 214 defines an annular region 260 between the inner surface 254B of the piston wall 254 and the outer surface 280A of the stem 280.

The first part 240 and second part 242 of the body define an annular region 261 between the outer surface 240A of the first part 240 and the inner surface of the second part 242 which surrounds the first part 240. Region 261 is fluidly connected to region 260. Together region 260 and region 261 form a low pressure chamber 222.

The control chamber 215 is generally cylindrical and is defined by the region of inner surface 240B between the end surface 294 of second end 292D and the restrictor 244. The control chamber 215 is fluidly connected to the control volume vent valve 220 by a passage 249 in a wall of the control chamber which extends through the first part 240 from the inner surface 240B to the control chamber vent valve 220. Passage 249 bypasses the high pressure chamber 219. The opposite side of the control chamber vent valve 220 is fluidly connected to the low pressure chamber 222 by a passage 249′. The control chamber vent valve 220 may be operated by a solenoid (not shown). When the control chamber vent valve 220 is open, the control chamber 215 is connected to the low pressure chamber 222 via passages 249 and 249′. When the control chamber vent valve 220 is closed, passage 249 is isolated from passage 249′ and fluid communication between the control chamber 215 and the low pressure chamber 222 is prevented.

The low pressure chamber 222 is generally annular and is fluidly connected to pump 228 (shown schematically) via line 250. A return line 252 extends between the line 250 and the tank T from a location downstream of the pump 228. A pressure relief valve (PRV) 226 is provided on the return line 252. When fluid pressure in line 250 is at or below a threshold valve, for example the output pressure from the pump 228, the PRV 226 remains closed and fluid is pumped by the pump 228 along the line 250 towards the low pressure chamber 222. When fluid pressure in line 250 is above the threshold, for example the output pressure from the pump 228, the PRV 226 opens and fluid is vented to tank T along return line 252. The low pressure chamber 222 is fluidly connected to the high pressure chamber 219 by a passage 253 in which a check valve 225 is located. The check valve 225 is configured to allow fluid to flow from the low pressure chamber 222 into the high pressure chamber 219 and to substantially prevent fluid from flowing in the opposite direction.

The accumulator chamber 271 may have a maximum volume of from 2 to 20 times the maximum volume of the nozzle chamber 223. The accumulator chamber 271 may have a maximum volume of from 400 to 4000 times the maximum volume of the control chamber 215. The accumulator chamber 271 may have a maximum volume of from 7 to 700 times the maximum volume of the high pressure chamber 219. For example, the accumulator chamber 271 may have a maximum volume of from 2 to 20 cc. In one particular example, the accumulator chamber has a maximum volume of 7 cc, the control chamber 215 has a maximum volume of 0.005 cc, the high pressure chamber 219 has a maximum volume of 0.3 cc, and the nozzle chamber 223 has a maximum volume of 1 cc.

Operation of the injector apparatus is as follows:

Prior to injection, for example at the start of the compression stroke of the piston 234, the injector apparatus 210 is in the primed condition. In the primed condition, the high pressure chamber 219, accumulator chamber 271, control chamber 215 and nozzle chamber 223 are all primed with fluid supplied from the tank T via pump 228 and line 250. The fluid is at relatively low pressure (e.g. 3-5 bar) and is supplied to the low pressure chamber 222 via line 250 from which it enters the high pressure chamber 219 through check valve 225 and passage 253, enters the accumulator chamber 271 from the high pressure chamber 219 via check valve 224, enters the control chamber 215 from the accumulator chamber 271 via restrictor orifice 244′, and enters the nozzle chamber 223 from the control chamber 215 via passage 251. The first piston 214 is in its lowermost position (as shown in FIG. 11) such that shoulder 255 of the first piston 214 is in engagement with shoulder 248 of the body. The valve element 292 is also in its lowermost position such that valve surface 293 is in engagement with valve seat 247 thereby isolating the orifices 276 from the nozzle chamber 223. Control volume vent valve 220 is closed. PRV 226 is closed. The fluid pressures within the control chamber 215 and the nozzle chamber 223 are equalised by orifice 244′ and passage 251 and so the valve member 292 remains in the closed position and the valve member 292 is engaged with valve seat 247 via valve surface 293.

As the piston 234 ascends within cylinder 236 during the compression stroke of the internal combustion engine 238, pressure is developed within the combustion chamber 232. This increasing pressure (P_{comb}) acts on the working area (A_{fp}) of the first piston 214 to generate a force (F_{fp}) in the direction of arrow A, which can be expressed as:

F_{fp}=P_{comb}×A_{fp}

The first piston working area (A_{fp}) is defined by the area of the end wall 256. Where the first piston 214 is circular, the working area of the first piston 214 is equal to (π/4)D². Thus, as the pressure P_{comb} within the combustion chamber 232 increases, so too does the force F_{fp} on the first piston 214 in the direction of arrow A.

The effective area (Aₕₚ) of the high pressure piston 218, or “high pressure piston working area” is defined by the area of the end surface 280C. Where the end surface 280C of the stem has a circular annular shape, as in this example, then the high pressure piston working area (Aₕₚ) is equal to π/4× (outer surface 280A diameter−inner surface 280B diameter)².

Once the pressure P_{comb} exceeds the supply pressure from the pump 228, and therefore exceeds the pressure Pₗₚ in the low pressure chamber 222, the first piston 214 begins to move upward, i.e. in the direction of arrow A. This causes the high pressure piston 218 to ascend within the high pressure chamber 219, thereby reducing the volume of the high pressure chamber 219 and increasing the pressure Pₕₚ in the high pressure chamber 219. This closes the check valve 225 between the high pressure chamber 219 and the low pressure chamber 222. Fluid which is displaced from the low pressure chamber 222 by the upward movement of the first piston 214 is vented to tank T via line 250 and the PRV 226.

As will be appreciated, the high pressure piston working area Aₕₚ is significantly smaller than the effective area A_{fp} of the first piston 214, and as such the pressure within the high pressure chamber 219 will be greater than the pressure created in the combustion chamber 232 of the internal combustion engine 238. This allows extremely high injection pressures to be generated, e.g. above 3000 bar. The pressure Pₕₚ in the high pressure chamber 219 is defined by the pressure P_{comp} in the combustion chamber 232 multiplied by the ratio of the working areas of the first piston 214 and the high pressure piston 218, i.e. Pₕₚ=P_{comp}×(A₁/A₂), minus the pressure Pₗₚ in the low pressure chamber 222.

As the pressure in the high pressure chamber 219 increases, fluid is transferred to the accumulator chamber 271 via check valve 224 thereby charging the accumulator chamber 271. Fluid is also transferred to the control chamber 215 and to the nozzle chamber 223 via restrictor orifice 244′ and passage 251. As in the primed condition, the fluid pressures within the control chamber 215 and the nozzle chamber 223 are equalised through orifice 244′ and passage 251 and so the valve 291 remains closed despite the increase in fluid pressure.

In order to start injection, a control system (not shown) causes the control volume vent valve 220 to open e.g. by powering a solenoid. This fluidly connects passage 249 to passage 249′, and hence fluidly connects the control chamber 215 to the low pressure chamber 222. Thus, the pressure in the control chamber 215 falls as fluid is vented from the control chamber 222 to the low pressure chamber and back to tank T via line 250 and PRV 226.

Due to the presence of restrictor 244 and the small size of the orifice 244′ relative to the bore of passage 249, fluid leaves the control chamber 215 via passage 249 quicker than it can enter the control chamber 215 from the accumulator chamber 271 via orifice 244′. This results in a pressure differential between the control chamber 215 and both the accumulator chamber 271 and the nozzle chamber 223. Thus, as the pressure drops in the control chamber 215, the pressure in the nozzle chamber 223 remains high, thereby causing the valve member 292 to move in the direction of arrow A, i.e. upwardly when viewing FIG. 11, so as to disengage the valve surface 293 from the valve seat 247 and fluidly connect the nozzle chamber 223 with the injector orifices 276. This allows the fluid within the nozzle chamber 223 to be injected through the orifices 276 into the internal combustion chamber, thereby initiating combustion.

As fluid is injected, the first piston 214 progressively moves in the direction of arrow A, i.e. rises when viewing FIG. 11, and continues to compress the high pressure chamber 219 and thereby supply high pressure fluid to the accumulator chamber 271. While the pressure Pₕₚ in the high pressure chamber 219 remains higher than pressure P_{comp} in the control chamber 215, the valve surface 293 of the valve element 292 remains disengaged from the valve seat 247. In this manner, the injector nozzle 216 continues to inject fuel into the combustion chamber while fluid from the control chamber 215 is vented to tank.

In order to stop injection, the control volume vent valve 220 is closed thereby isolating passage 249 from passage 249′ and hence isolating the control chamber 215 from the low pressure chamber 222 and the tank T. Fluid flows from the accumulator chamber 271 to the control chamber 215 via the orifice 244′ to bring the pressure in the control chamber 215 back up to that of the accumulator chamber 271 and the nozzle chamber 223. Once the pressure differential between the control chamber 215 and the nozzle chamber 223 is small enough to be overcome by the spring by which the valve element 292 is biased towards the closed position, the valve element 292 returns to the closed position in which the valve surface 293 engages with the valve seat 247 thereby closing valve 291 and isolating the injector orifices from the high pressure chamber 219 whereupon injection ceases.

Continued upward movement of the first piston 214 further reduces the volume of the high pressure chamber 219 and increases the pressure therein according to the ratio of the high pressure piston working area and the first piston, as discussed above. Provided the fluid pressure in the high pressure chamber 219 exceeds that of the accumulator chamber 271, fluid is transferred to the accumulator chamber 271 from the high pressure chamber 219 via check valves 224 to charge the accumulator.

Note that even once fluid injection is stopped, the chambers downstream of check valve 224, i.e. the accumulator chamber 217, control chamber 215 and nozzle chamber 223, remain pressurised by virtue of check valve 224.

Injection typically occurs towards the end of a compression stroke and/or at the start of a combustion (expansion) stroke. Because these chambers remain pressurised at the end of injection, further injection is possible during the particular compression/combustion stroke by reopening the control chamber vent valve 220. Such “double” injection is referred to as “double strike” injection. As will be appreciated, the present invention allows for two or more distinct injections (i.e. multi-strike injection) to occur during a single compression/combustion stroke.

By providing an accumulator which is operable to supply fluid under pressure through an injector orifice into an associated chamber and configuring the high pressure chamber such that it is operable to pressurise the accumulator with fluid, the present invention allows for two or more distinct injections to occur during a single compression/combustion stroke.

Once injection for a particular compression/combustion stroke has finally stopped, the pressure within the combustion chamber will fall significantly, typically when an exhaust valve or valves are opened, and consequently the pressure within the high pressure chamber 219 will also fall significantly. The pressure within the combustion chamber 232 will remain at a relatively low pressure during an exhaust stroke and during an inlet stroke. At some time during the time period when the pressure in the combustion chamber is relatively low, the injector apparatus will be re-primed with fuel in time for the next injection event which will occur at the next compression/combustion stroke.

In order to re-fill or re-prime the injector apparatus, the pump provides pressurised fluid (e.g. at around 3-5 bar) which flows along line 250 into the low pressure chamber 222 to fill the low pressure chamber 222 and push the first piston 214 to the start position in which the shoulder 255 of the first piston abuts the shoulder 248 on the body 212. This expands the high pressure chamber 219 back to its starting volume and reduces the pressure Pₕₚ therein. Once the pressure Pₕₚ in the high pressure chamber 219 falls below the pressure Pₗₚ in the low pressure chamber 222, check valve 225 opens and the high pressure chamber 219 is primed with fluid via passage 253.

By providing an accumulator which is pressurised with fluid by the high pressure chamber and is operable to supply fluid under pressure through the injector orifice, the available injection pressure for the next engine cycle is increased. This allows greater flexibility in deciding the optimal injection timing while maintaining maximum potential injection pressure. Without the accumulator, the maximum available injection pressure at any given moment is limited by the pressure P_{comp}×the area ratio between A_{fp} and Aₕₚ. Consequently, if it were desired to inject prior to TDC, when peak cylinder pressure has not yet been reached, the injection pressure would be limited. Similarly, if it were desired to inject late after TDC, when peak cylinder pressure has passed, injection pressure would again be limited. The accumulator provides the freedom to adjust injection timing whilst maintaining an injection pressure which would not otherwise be achievable. The accumulator serves to damp out the highly dynamic changes in fluid pressure that would otherwise be seen in the injector.

Although the high pressure piston 218 is illustrated as being unitary with the first piston 214, this need not necessarily be the case. Instead, the high pressure piston 218 could be positioned elsewhere in the injector apparatus. For example, the control piston could be fixed to the first part 240 of the injector body 212 and moveable within a bore defined in the first piston. Alternatively, the high pressure piston may be remote from the first piston with the first piston being configured to move the high pressure piston directly or indirectly via one or more intermediate components or chambers. One or both of the first piston and the high pressure piston may be aligned with or offset from the central axis of the injector

Although a single high pressure piston is illustrated, the injector apparatus may comprise two or more high pressure pistons.

Further, although the high pressure chamber and the control chamber are illustrated as being re-primed via the low pressure chamber, one or both of the high pressure chamber and control chamber may be in fluid communication with the feed line via one or more passages which bypass the low pressure chamber.

Additionally, while the accumulator is illustrated as comprising a chamber which is defined by the first part of the body of the injector and located directly above the control chamber and valve element, it may be positioned elsewhere within the body. It may also be connected to the control chamber and nozzle chamber by one or more additional passages. For example, the accumulator may be offset from the control chamber in the first part, or may be defined by the second part of the injector body. In other embodiments, the accumulator need not be integral with the injector body but may be provided as an external accumulator which is mounted on or adjacent to the injector body, as discussed below in relation to FIG. 15.

FIG. 15 shows a perspective view of an injector apparatus 410. The injector 410 is similar in structure and operation to injector 210. However, unlike in the injector 210, the accumulator 470 is external to the injector body 412. The accumulator 470 includes one or more accumulator chambers (not shown) defined within an accumulator housing 473 which is mounted on the injector body 412, for example fixed to a top cap 474 of the injector apparatus 410 in which the fuel fittings and electrical connections are provided. The one or more accumulator chambers are fluidly connected to the high pressure chamber by an external hose 475 which is sealed against the accumulator housing and the injector body 412 by hose connectors 476. The accumulator 470 may be fluidly connected to the nozzle chamber of the injector 410 via a passage (not shown) which is either within the hose 475 or provided in an additional hose. Alternatively, or in addition, the accumulator may be fluidly connected to the nozzle chamber of one or more further injectors. In this manner, where the internal combustion engine comprises multiple cylinders, each with one or more injectors, the pressure within the associated cylinder of a first injector may be used to pressurise the nozzle chamber of a second injector. This may be advantageous in terms of injection timing relative to the position of the piston of the associated chamber. Further, the accumulator 470 may be shared by two or more injectors of multiple cylinders of the engine. For example, the accumulator 470 may be a single common accumulator which is shared by all of the injectors of the internal combustion engine.

With reference to FIGS. 16 to 20, there is shown an injector apparatus 310 having a body 312, a first piston 314, an injector nozzle 316, a control piston 317, and a high pressure piston 318.

The injector apparatus further includes a control chamber vent valve 320 and a high pressure chamber vent valve 321.

In use, the injector apparatus is attached to a cylinder head 330 (shown schematically) or the like with the nozzle 316 being configured to inject fluid into an associated chamber 332, such as an internal combustion chamber. The associated chamber 332 varies in volume as a piston 334 reciprocates within a cylinder 336 of an internal combustion engine 338.

In use, a pump 328 may be connected to a tank T. The tank T may supply fluid to the pump 328 and may also receive fluid from the injector apparatus as will be further described below.

The body 312 has a first part 340 and a second part 342. The second part 342 is secured to the first part 340 (details of which are not shown).

The second part 342 includes a bore 346 having an internal diameter D, in one example D=25 mm. The second part 342 has a shoulder 348.

The first part 340 includes a passage 349 being associated with the control chamber vent valve 320 and a passage 351 associated with the high pressure chamber vent valve 321. First part 340 further includes a fill line 350 (shown schematically) associated with a fill valve 324 and a return line 352 (shown schematically) associated with a return valve 325.

As best seen in FIG. 17, the first piston 314 has a piston wall 354 sized so that its outer surface 354A is a close sliding fit within bore 346 of the second part 342 so as to essentially seal the wall 354 with the bore 346. The first piston 314 includes a shoulder 355 and an end wall 356 having a bore 357 in which the injector nozzle 316 is secured. The bore 357 has a chamfer 358 at its lower end. The first piston 314 is slidable within the bore 346 and its lowermost position is defined by engagement of shoulder 355 with the shoulder 348 on the body 312.

Unitarily formed with the first piston 314 is a control piston 317. Control piston 317 depends upwardly from end wall 356 of the first piston 314 and has a cylindrical annular stem 380 with an outer surface 380A, an inner surface 380B and an end surface 380C. Inner surface 380B defines a high pressure bore 380B′. End surface 380C defines the control chamber working area, as will be further described below.

As best seen in FIG. 18, the first part 340 of the injector body 312 is generally elongate and includes an outer surface 340A, an inner surface 340B, an end surface 340C, and an upper wall 340D. A high pressure piston 318 depends downwardly from the upper wall 340D into a control chamber bore 340B′ defined by the inner surface 340B of the first part 340. The high pressure piston 318 has an outer surface 318A, an inner surface 318B and an end surface 318C. In this manner, the high pressure piston 318 is fixed relative to the body 312. The inner surface 318B defines a central passage 351.

Referring again to FIG. 16, the upper end of the control piston stem 380 extends into the control chamber bore 340B′ defined by the inner surface 340B of the first part 340 so that there is a clearance between the end surface 380C of the control piston stem 380 and the upper wall 340D. The lower end of the high pressure piston 318 extends into the upper end of the high pressure bore 380B′ defined by the inner surface 380B of the control piston stem 380 so that there is a clearance between the end surface 318C of the high pressure piston 318 and the injector nozzle 316 at the lower end of the high pressure bore 380B′.

The clearance between the end surface 380C of the control piston stem 380 and the upper wall 340D defines a control chamber 315 which is bounded by the inner surface 340B of the first part 340, the outer surface 318A of the high pressure piston 318, the upper wall 340D and the annular end surface 380C of the control piston 317. The clearance between the end surface 318C of the high pressure piston 318 and the injector nozzle 316 defines a high pressure chamber 319 which is bounded by the inner surface 380B of the control piston stem 380, the injector nozzle 316 and the end surface 318C of the high pressure piston 318. In this manner, the first piston 314 defines at least part of the high pressure chamber 319. In particular, the control piston 317, which forms part of the first piston 314, defines the high pressure bore 380B′ of the high pressure chamber 319.

The control piston stem 380 is sized so that the outer surface 380A of the stem 380 forms a close sliding fit within the control chamber bore 340B′ of the first part 340 so as to essentially seal outer surface 380A with the bore 340B′. The control piston stem 380 is also sized so that the outer surface 318A of the high pressure piston 318 forms a close sliding fit within the high pressure bore 380B′ of the control piston stem 380 so as to essentially seal the outer surface 318A with the high pressure bore 380B′ defined by the inner surface 380B of the control piston stem 380. The close sliding fit between the stem 380 and the adjacent components allows the control piston 317 to slide axially relative to the first part 340 and the high pressure piston 318 to vary the volumes of the control chamber 315 and the high pressure chamber 319.

The first piston 314 defines an annular region 360 between the inner surface 354B of the piston wall 354 and the outer surface 380A of the stem 380. The first part 340 and second part 342 of the body define an annular region 361 between the outer surface 340A of the first part 340 and an inner surface 342B of the second part 342 which surrounds the first part 340. Region 361 is fluidly connected to region 360. Together region 360 and region 361 form a low pressure chamber 322.

The control chamber 315 is generally cylindrical and annular. At an end of the control chamber 315 opposite control piston 317, is a passage 349 which fluidly connects control chamber 315 to a control chamber vent valve 320. The opposite side of the control chamber vent valve 320 is fluidly connected to the low pressure chamber 322 by a passage 349′. The control chamber vent valve 320 is operated by a solenoid 320′. When the control chamber vent valve 320 is open, the control chamber 315 is connected to the low pressure chamber 322 via passages 349 and 349′. When the control chamber vent valve 320 is closed, passage 349 is isolated from passage 349′ and fluid communication between the control chamber 315 and the low pressure chamber 322 is prevented.

The high pressure chamber 319 is generally cylindrical and is connected to a high pressure chamber vent valve 321 via the central passage 351 in the high pressure piston 318. The opposite side of the high pressure chamber vent valve 321 is fluidly connected to the low pressure chamber 322 by a passage 351′. The high pressure chamber vent valve 321 is operated by a solenoid 321′. When the high pressure chamber vent valve 321 is open, the high pressure chamber 319 is connected to the low pressure chamber 322 via passages 351 and 351′. When the high pressure chamber vent valve 321 is closed, passage 351 is isolated from passage 351′ and fluid communication between the high pressure chamber 319 and the low pressure chamber 322 is prevented.

The low pressure chamber 322 is generally annular and is fluidly connected to pump 328 (shown schematically) via fill valve 324 and fill line 350, and is fluidly connected to tank T (shown schematically) via return valve 325 and return line 352. When the fill valve 324 is open, the low pressure chamber 322 is in fluid communication with the fill line 350 and fluid can be pumped into the low pressure chamber 322 by the pump 328, provided the output pressure from pump 328 is higher than the pressure in the low pressure chamber 322. When the fill valve 324 is closed, the low pressure chamber 322 is isolated from the fill line 350 and from the pump 328. When the return valve 325 is closed, the low pressure chamber 322 is in fluid communication with the return line 352 and fluid can be vented from the low pressure chamber 322 to the tank T via the return line 352. When the return valve 325 is closed, the low pressure chamber 322 is isolated from the return line 352.

As best seen in FIGS. 19 and 20, the injector nozzle 316 includes a stem 362 having an outer surface 362A, sized to be a close fit or a press fit in the bore 357 in the end surface 356 of the first piston 314. The stem 362 also has an external thread 362B on its outer surface 362A and a bore 363 defined by a bore wall 364, an internal thread 365 and a shoulder 366. In one example the bore 363 has a diameter d of 3.5 mm. The bore 363 in the injector nozzle 316 is smaller than the diameter of the bore 357 in the end surface 356 of the first piston 314. The injector nozzle 316 also includes an end wall 367 having a flange 368. The flange 368 has a flange surface 368A. Cross-drilling 369 fluidly couples the bore 363 to the outer surface 362A of the stem 362 in a region near the flange 368.

Located within the bore 363 of the injector nozzle 316 is a valve 391 which is retained by the internal thread 365. The valve 391 has a valve body 391A which defines a central bore 391B. The upper end of the central bore 391B is open to the bore 363 of the stem 362. The lower end of the central bore 391B defines a valve seat 391C. The valve 391 also includes a moveable valve element 392 inside the central bore 391B which is biased towards the closed position and has a valve surface 393 which selectively engages and disengages with the valve seat 391C to open and close the valve 391.

The injector nozzle 316 further includes an annular nozzle ring 370 having a first surface 371, a second surface 372 and a third surface 373. The first surface includes a series of generally radially orientated grooves 374. In this example, the first surface 371 is flat but it could be at an angle, for example it could be frustoconical. The second surface 372 is frustoconical. The third surface is cylindrical. The nozzle ring 370 also includes a chamfer 375 between the third surface 373 and the first surface 371. When the injector nozzle 316 is assembled into the first piston 314, the nozzle ring 370 is forced into the “wedge” shape defined between the chamfer 375 and the outer surface 362A of the stem 362. In this position, the first surface 371 is sealed against the flange surface 368A, the second surface 372 is sealed against the chamfer 358 and the third surface 373 is sealed against the stem wall 362A. When the first surface 371 of the nozzle ring is in engagement with the flange surface 368A, the grooves 374 define a plurality of injector holes 376.

Operation of the injector apparatus 310 is as follows:

Prior to injection, for example at the start of the compression stroke of the piston 334, the injector apparatus 310 is in the primed condition. In the primed condition, the control chamber 315, high pressure chamber 319 and low pressure chamber 322 are all primed with fluid supplied from the tank T, via pump 328 and fill line 350. The fluid is at relatively low pressure (e.g. 3-5 bar). The first piston 314 is in its lowermost position (when considering FIG. 16) such that shoulder 355 of the first piston 314 is in engagement with shoulder 348 of the body 312. The valve element 392 is also in its uppermost position such that valve surface 393 is in engagement with valve seat 391C thereby isolating the orifices 376 from the high pressure chamber 319. Control chamber vent valve 320 is closed. High pressure chamber vent valve 321 is closed. Fill valve 324 is closed. Return valve 325 is open.

As the piston 334 ascends within cylinder 336 during the compression stroke of the internal combustion engine 338, pressure is developed within the combustion chamber 332. This increasing pressure (P_{comb}) acts on the first working area (A_{fp}) of the first piston 314 to generate a force (F_{fp}) in the direction of arrow A, which can be expressed as:

F_{fp}=P_{comb}×A_{fp}

Where the first piston 314 has a circular working area, as in this example, then A_{fp} is equal to (π/4)D². Thus, as the pressure P_{comb} within the combustion chamber 332 increases, so too does the force F_{fp} on the first piston 314 in the direction of arrow A. However, the first piston does not move in the direction of arrow A, because the upward force on piston 314 is resisted by fluid within the control chamber 315 being hydraulically locked by the fluid in the control chamber 315 (by virtue of control chamber vent valve 320 being closed). This hydraulic locking results in a reaction force (R_{cp}) in direction B on the end surface 380C of stem 380 of the control piston 317 from the fluid in the control chamber 315.

The effective area of the control piston 317, or “control piston working area”, facing the control chamber 315 is equal to the area of the end surface 380C. Where the end surface 380C of the control piston 317 has a circular annular shape, as in this example, then the control piston working area (A_{cp}) equates to π×(outer surface 380A diameter−inner surface 380B diameter)²/4.

In order to start injection, a control system (not shown) causes the control chamber vent valve 320 to open, e.g. by powering the solenoid 320′. This fluidly connects passage 349 to passage 349′, and hence fluidly connects the control chamber 315 to the low pressure chamber 322. The return valve 325 may also be opened by the control system to fluidly connect the low pressure chamber 322 to the tank T via the return line 322. With the control chamber vent valve 320 open, fluid in the control chamber 315 vents to the low pressure chamber 322. Thus, the control chamber 315 no longer provides a hydraulic lock. The pressure within the combustion chamber 332 acting on first piston 314 thereby moves first piston 314 upwardly as fluid is vented from the control chamber 315 through the control chamber vent valve 320. Upward movement of the first piston 314, i.e. in the direction of arrow A, causes the volume of the high pressure chamber to decrease, since the injector nozzle 316 ascends with the first piston 314 whereas the high pressure piston 318 remains in place. Thus, the pressure in the high pressure chamber 319 increases. This increases the force exerted on the valve 391 in the direction of arrow B, i.e. downwardly in FIG. 16, by fluid in the high pressure chamber. Once pressure in the high pressure chamber 319 is sufficiently high to overcome the spring force on the valve element 392, the valve surface 393 of valve element 392 is disengaged from the valve seat 391C to open valve 391 and thereby fluidly connect the high pressure chamber 319 with the injector orifices 376. Fuel passes from through cross-drillings 369 and out of the injector orifices 376 into the combustion chamber 332 thereby initiating combustion.

The effective area of the high pressure piston 318, or “high pressure working area” facing the high pressure chamber 319 is equal to the area of the end surface 318C. Where the end surface 318C of the high pressure piston 318 has a circular annular shape, as in this example, and the high pressure vent valve 321 is closed, then the high pressure piston working area (A_{cp}) equates to π×(outer surface 318A diameter)²/4.

The pressure in the high pressure chamber is defined by the pressure in the combustion chamber 332 and the ratio of the working areas of the first piston 314 and the high pressure piston 318, i.e.:

Pₕₚ=P_{comb}×(A_{fp}/Aₕₚ)

As fluid is injected, the first piston 314 progressively moves in the direction of arrow A, i.e. rises when viewing FIG. 16. However, provided fluid pressure in the high pressure chamber 319 remains sufficient to keep the valve 391 open, the injector nozzle 316 can continue to inject fuel as fluid from the control chamber 315 is vented to tank.

As will be appreciated, the effective area of the high pressure piston 318 is significantly smaller than the effective area of the first piston 314 and as such the pressure within the high pressure chamber 319 will be greater than the pressure created in the combustion chamber 332 of the internal combustion engine. This allows extremely high injection pressures to be generated, e.g. above 3000 bar. As will also be appreciated, the effective area of the control piston 317 is smaller than the effective area of the first piston 314 and larger than the effective area of the high pressure piston 318. Consequently, the pressure within the control chamber 315 will be greater than the pressure created in the combustion chamber 332 of the internal combustion engine 338 and will be less than the pressure in the high pressure chamber 319.

In order to stop injection, there are two options:

The first option is to open the high pressure chamber vent valve 321. This causes the high pressure chamber 319 to be vented to the tank T via the low pressure chamber 322 and return line 352. The drop in pressure in the high pressure chamber 319 causes the valve 391 to close thereby preventing further injection. The first piston 314 will continue to move upwardly as the control chamber 315 and high pressure chamber 319 both vent to tank. Upward movement of first piston 314 will stop when the piston wall 354 comes into contact with the top end of region 361.

The second option is to close the control chamber vent valve 320. This isolates passage 349 from passage 349′ and hence isolates the control chamber 315 from the low pressure chamber 322 and the tank T. The control chamber 315 is then hydraulically locked. This decelerates upward movement of the first piston 314 and allows the pressure in the high pressure chamber 319 to reduce to close the valve 391 thereby isolating the injector orifices 376 from the high pressure chamber 319 whereupon injection ceases. Note that even though injection has stopped, the high pressure chamber 319 remains pressurised by virtue of the pressure within the combustion chamber 332. Injection typically occurs towards the end of a compression stroke and/or at the start of a combustion (expansion) stroke. Because the high pressure chamber remains pressurised at the end of injection, further injection is possible during the particular compression/combustion stroke by reopening the control chamber vent valve 320. Such “double” injection is referred to as “double strike” injection. As will be appreciated, the present invention allows for two or more distinct injections (i.e. multi-strike injection) to occur during a single compression/combustion stroke.

By hydraulically locking the first piston 314 using fluid in a control chamber 315 which is pressurised by the control piston 317 and has a smaller volume than the low pressure chamber 322, the amount of fluid that must be vented during each injection cycle can be reduced relative to arrangements which require venting of the low pressure chamber.

Once injection for a particular compression/combustion stroke has finally stopped, the pressure within the combustion chamber will fall significantly, typically when an exhaust valve or valves are opened, and consequently the pressure within the high pressure chamber 319 will also fall significantly. The pressure within the combustion chamber 332 will remain at a relatively low pressure during an exhaust stroke and during an inlet stroke. At some time during the time period when the pressure in the combustion chamber is relatively low, the injector apparatus will be re-primed with fuel in time for the next injection event which will occur at the next compression/combustion stroke.

In order to re-fill or re-prime the injector, the return valve 325 is closed and the fill valve 324, control chamber vent valve 320, and high pressure chamber vent valve 321 are all opened when the pressure in the combustion chamber P_{comb} is less than the supply pressure from the pump 328. For example, at or towards the end of the expansion stroke. The pump 328 provides pressurised fluid (e.g. at around 3-5 bar) which flows along fill line 350 into the low pressure chamber 322 to fill the control chamber 315, high pressure chamber 319 and low pressure chamber 322 and push the first piston 314 to the start position in which the shoulder 355 of the first piston abuts the shoulder 348 on the body 312.

Although the control piston 317 is illustrated as being unitary with the first piston 314, this need not necessarily be the case. Instead, the control piston 317 could be positioned elsewhere in the injector apparatus. For example, the control piston could be fixed to the first part 340 of the injector body 312 and moveable within a bore defined in the first piston. Alternatively, the control piston and control chamber could be offset from the central axis of the injector. Similarly, although the high pressure piston 319 is illustrated as being unitary with the first part 340, this need not necessarily be the case. Instead, the high pressure piston 319 could be positioned elsewhere in the injector apparatus. For example, the high pressure piston could be fixed to and moveable with the first piston 314 within a bore defined in the first part 340. Alternatively, the high pressure piston and high pressure chamber could be offset from the central axis of the injector and connected to the injector nozzle by one or more passages.

Although a single high pressure piston and a single control piston are illustrated, the injector apparatus may comprise two or more high pressure pistons and/or two or more control pistons.

Further, although the high pressure chamber and the control chamber are illustrated as being re-primed via the low pressure chamber, one or both of the high pressure chamber and control chamber may be in fluid communication with the feed line via one or more passages which bypass the low pressure chamber.

Although the return line and feed line are schematically illustrated as separate lines, in practice, they may be provided as a single line.

1. An injector apparatus for injecting fluid under pressure into an associated chamber, the apparatus including
a body,
a first piston moveable in the body, the first piston defining a first working area facing an associated chamber,
a high pressure piston defining a high pressure working area facing a high pressure chamber,
the first working area being greater than the high pressure working area, the first piston being operable to compress fluid in the high pressure chamber using the high pressure piston
the injector apparatus having a first configuration having a first ratio of the first working area to high pressure working area and having a second configuration having a second ratio of the first working area to the high pressure working area,
wherein a first ratio is different from the second ratio.

2. The injector apparatus as defined in claim 1 wherein the high pressure piston is defined by a plurality of high pressure pistons and the high pressure chamber is defined by a corresponding plurality of high pressure chambers and
the high pressure working area of first ratio is defined by a first selection of the plurality of high pressure pistons facing the corresponding high pressure chambers and
the high pressure working area of the second ratio is defined by a second selection of the plurality of high pressure pistons facing the corresponding high pressure chambers,
wherein the first selection is different to the second selection.

3. The injector apparatus as defined in claim 2 wherein the first selection is all of the plurality of high pressure pistons facing the corresponding high pressure chambers and the second selection is not all of the plurality of high pressure pistons facing the corresponding high pressure chambers.

4. The injector apparatus as defined in claim 2 wherein the first selection is not all of the plurality of high pressure pistons facing the corresponding high pressure chamber and the second selection is not all of the plurality of high pressure pistons facing the corresponding high pressure chamber.

5. The injector apparatus as defined in claim 1, wherein the injector apparatus has a third configuration having a third ratio of the first working area to high pressure working area wherein the third ratio is different to the first ratio and second ration.

6. The injector apparatus as defined in claim 10, wherein the high pressure working area of the third ratio is defined by a third selection of the plurality of high pressure pistons facing the corresponding high pressure chambers, the third selection being different to the first selection and second selection.

7. The injector apparatus as defined in claim 1, wherein when in the second configuration at least one high pressure chamber is vented to a low pressure region.

8. The injector apparatus as defined in claim 1, further including a return spring configured to bias the first piston towards the associated chamber during use.

9. A reciprocating internal combustion engine comprising at least one combustion chamber and at least one injector apparatus as defined in claim 1, the at least one injector apparatus being configured to inject fluid under pressure into the at least one combustion chamber.

10. The injector apparatus as defined in claim 5, wherein the high pressure piston is defined by a plurality of high pressure pistons and the high pressure chamber is defined by a corresponding plurality of high pressure chambers and
the high pressure working area of first ratio is defined by a first selection of the plurality of high pressure pistons facing the corresponding high pressure chambers and
the high pressure working area of the second ratio is defined by a second selection of the plurality of high pressure pistons facing the corresponding high pressure chambers,
wherein the first selection is different to the second selection.
